(19) United States
(12) Patent Application Publication
(10) Pub. No.: US 2022/0413184 A1
(43) Pub. Date: Dec. 29, 2022

(54) PROFILE GENERATION UTILIZING SIGNALS FROM VEHICLE DEVICES

(71) Applicant: Verizon Patent and Licensing Inc., Basking Ridge, NJ (US)

(72) Inventors: Koray A. Cagliergin, Tampa, FL (US); Jerry Gamble, JR., Grapevine, TX (US); Christopher N. DelRegno, Rowlett, TX (US)

(21) Appl. No.: 17/355,702

(22) Filed: Jun. 23, 2021

(51) Int. Cl. G01W 1/06; B60W 40/02

(52) U.S. Cl. CPC G01W 1/06; B60W 40/02; G01W 2203/00

(57) ABSTRACT

One or more computing devices, systems, and/or methods for generating profiles, such as weather profiles, based upon signals from vehicle devices are provided. In an example, a plurality of vehicle measure signals is received from a plurality of vehicle devices. A first vehicle measure signal of the plurality of vehicle measure signals is received from a first vehicle device, of the plurality of vehicle devices, connected to a first vehicle. The first vehicle measure signal is indicative of a first location of the first vehicle and one or more first vehicle measures determined using one or more first sensors of the first vehicle. A vehicle measure profile associated with a region is generated based upon the plurality of vehicle measure signals. The vehicle measure profile is indicative of one or more second vehicle measures at one or more locations within the region.

### BACKGROUND

Weather property information of a region may be used for one or more tasks. However, there are many regions that do not have publicly available weather property information or the weather property information is not easily ascertainable. Further, weather property information may be expensive to obtain which may prevent knowledge of weather property measures.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for generating profiles, such as weather profiles, based upon signals from vehicle devices, where a weather system receives a vehicle measure signal from a vehicle device according to some embodiments.

FIG. 1B is a diagram illustrating an example system for generating profiles, such as weather profiles, based upon signals from vehicle devices, where a group of vehicle measures is used to determine a first profile-indicated vehicle measure of a vehicle measure profile according to some embodiments.

FIG. 1C is a diagram illustrating an example system for generating profiles, such as weather profiles, based upon signals from vehicle devices, where a fourth vehicle measure associated with a time T2 is determined based upon a first vehicle measure associated with a time T1 and/or weather property information provided by one or more weather stations according to some embodiments.

FIG. 1D is a diagram illustrating an example system for generating profiles, such as weather profiles, based upon signals from vehicle devices, where a reference value is determined based upon a location of a sensor according to some embodiments.

FIG. 1E is a diagram illustrating an example system for generating profiles, such as weather profiles, based upon signals from vehicle devices, where an offset associated with a sensor is determined according to some embodiments.

FIG. 1F is a diagram illustrating an example system for generating profiles, such as weather profiles, based upon signals from vehicle devices, where a device altitude of a device is determined according to some embodiments.

FIG. 2 is a flow chart illustrating an example method for generating profiles, such as weather profiles, based upon signals from vehicle devices according to some embodiments.

FIG. 3 is an illustration of a scenario involving various examples of transmission mediums that may be used to communicatively couple computers and clients.

FIG. 4 is an illustration of a scenario involving an example configuration of a computer that may utilize and/or implement at least a portion of the techniques presented herein.

FIG. 5 is an illustration of a scenario involving an example configuration of a client that may utilize and/or implement at least a portion of the techniques presented herein.

FIG. 6 is an illustration of an example environment in which at least a portion of the techniques presented herein may be utilized and/or implemented.

FIG. 7 is an illustration of an example network that may utilize and/or implement at least a portion of the techniques presented herein.

FIG. 8 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

One or more systems and/or techniques for generating profiles, such as weather profiles, based upon signals from vehicle devices are provided. In some examples, weather information may be used to determine one or more weather property measures (e.g., at least one of barometric pressure measures, humidity measures, temperature measures, etc.) associated with a location, and/or the one or more weather property measures may be used for providing one or more services, such as at least one of sensor calibration, z-axis tracking of devices (e.g., determining an altitude of a device, a person and/or an object at the location), providing one or more emergency services, etc. In some systems, weather information associated with various locations may be determined based upon information that is at least one of received from weather property providers that receive compensation for providing the information, determined using dedicated sensors throughout the various locations, etc. Thus, determining the weather information in these systems may require high costs (e.g., the high costs may include at least one of compensation provided to weather property providers in exchange for weather information, costs of manufacturing and/or installing dedicated sensors throughout the various locations, etc.). Further, these systems may not be used to determine weather information of locations for which weather information is not provided by a weather property provider and/or weather information of locations for which dedicated sensors are not deployed. Alternatively and/or additionally, weather information determined using these systems may not have sufficient granularity due to, for example, an insufficient quantity of dedicated sensors deployed in a region.

Accordingly, as provided herein, vehicle measure signals may be received from vehicle devices deployed in vehicles. In an example, a vehicle measure signal may be indicative of one or more measures (e.g., one or more weather property measures and/or one or more other types of measures) determined using one or more sensors deployed in a vehicle. A vehicle measure profile (e.g., a weather profile, a barometric pressure profile, a humidity profile and/or a temperature profile) associated with a region may be generated based upon the vehicle measure signals. The vehicle measure profile may be indicative of vehicle measures at locations within the region. In an example, the vehicle measure profile may be indicative of weather property measures (e.g., at least one of barometric pressure measures, humidity measures, temperature measures, etc.) at locations within the region. Given a location, a weather property measure (e.g., at least one of a barometric pressure measure, a humidity measure, a temperature measure, etc.) at the location may be determined using the vehicle measure profile. In some examples, the weather property measure may be used to calibrate a sensor. Alternatively and/or additionally, the weather property measure (e.g., a barometric pressure measure) may be used to determine a device altitude of a device. Based upon the device altitude, locating information associated with the device may be determined (e.g., the locating information may comprise at least one of a building in which the device is located, a floor of the building on which the device is located, a part of the floor in which the device is located, etc.). One or more services (e.g., one or more emergency services) may be provided based upon the locating information.

By using one or more of the techniques herein to generate the vehicle measure profile based upon signals received from vehicle devices, vehicle measures (e.g., weather property measures, such as at least one of barometric pressure measures, humidity measures, temperature measures, etc.) associated with the region may be determined with increased granularity, accuracy and/or precision. Accordingly, one or more services, such as at least one of determining weather property measures of locations, calibrating sensors, determining device altitudes of devices, determining locating information of devices, providing one or more emergency services, etc., may be performed more accurately.

Alternatively and/or additionally, by using one or more of the techniques herein to generate the vehicle measure profile based upon signals from vehicle devices, weather property measures may be determined for areas for which sufficient weather information is not available to determine the vehicle measures (e.g., areas, such as non-urban areas and/or rural areas, that weather property providers have insufficient exposure to and/or where dedicated sensors are not deployed).

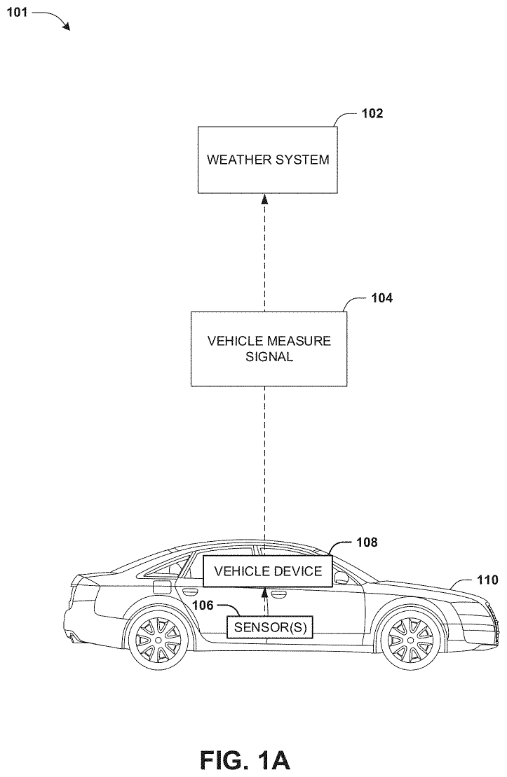

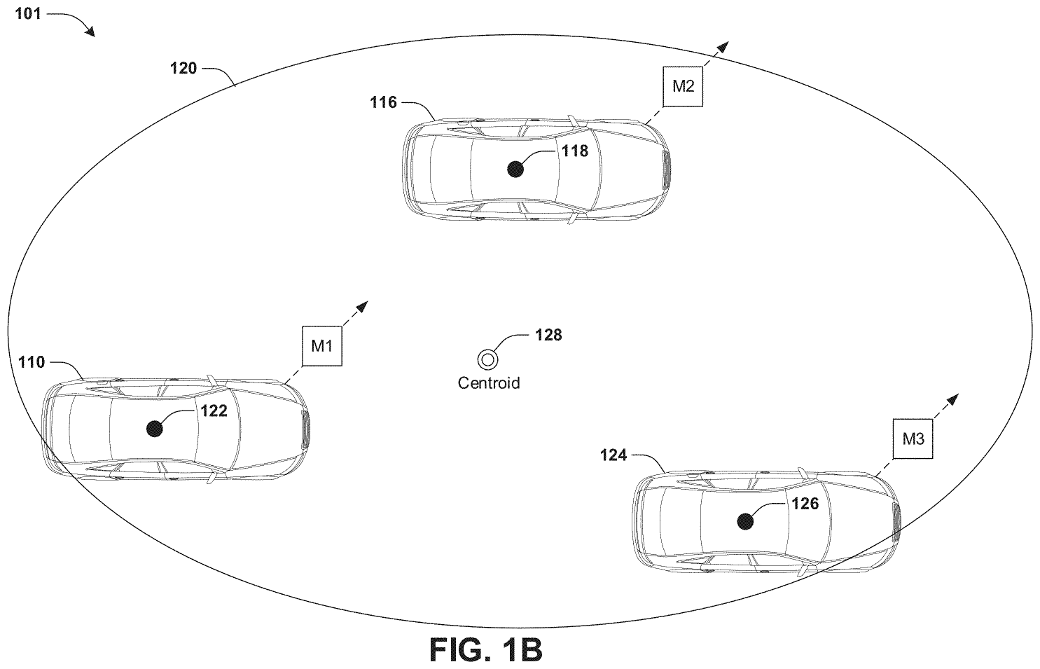

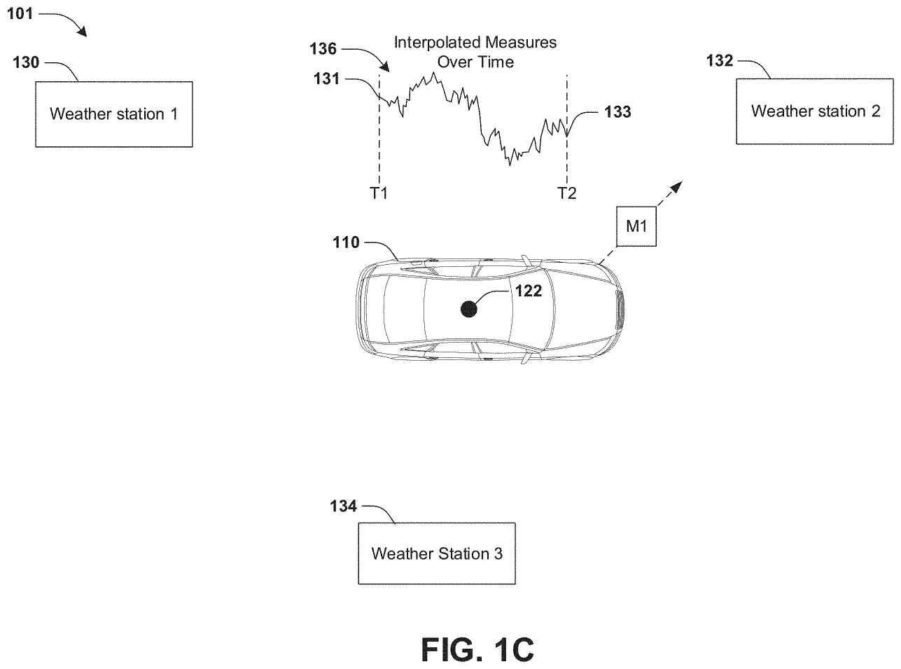

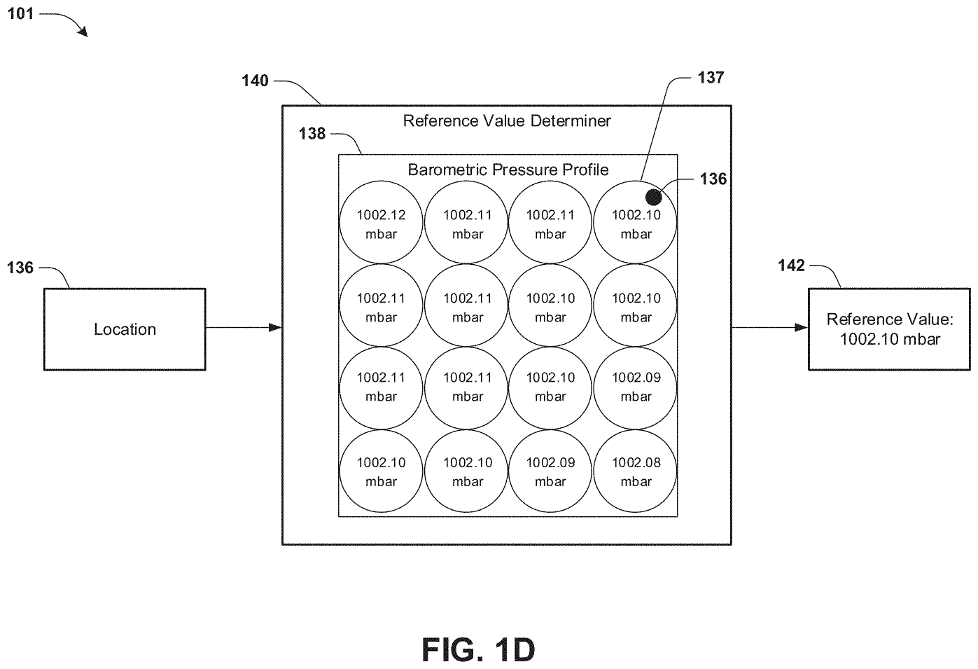

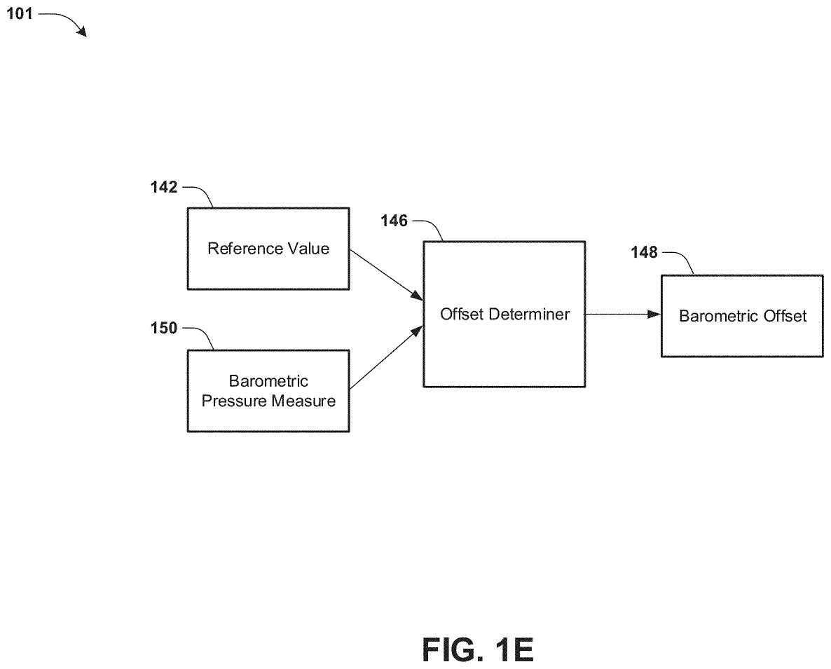

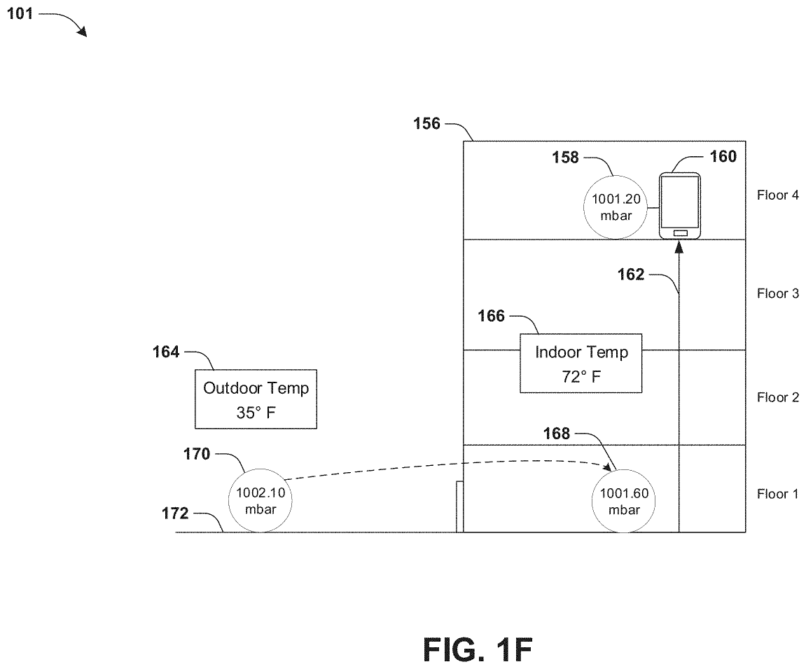

FIGS. 1A-1F illustrate examples of a system 101 for generating profiles, such as weather profiles, based upon signals from vehicle devices. FIG. 1A illustrates a first vehicle device 108, connected to a first vehicle 110, transmitting a first vehicle measure signal 104 to a weather system 102. In some examples, the first vehicle measure signal 104 may be indicative of a first location of the first vehicle 110, one or more first vehicle measures and/or a first time. For example, the first time may correspond to a time, such as a time of day, at which the first vehicle measure signal 104 is transmitted and/or at which one or more measurements are performed to determine the one or more first vehicle measures. The first vehicle measure signal 104 may be anonymized (for privacy protection, for example). In some examples, the first vehicle device 108 may transmit vehicle measure signals (such as the first vehicle measure signal 104) to the weather system 102 regularly and/or periodically. Alternatively and/or additionally, the first vehicle device 108 may transmit a vehicle measure signal (such as the first vehicle measure signal 104) to the weather system 102 in response to receiving a request (from the weather system 102, for example).

In some examples, the one or more first vehicle measures may be determined using one or more first sensors 106 and/or one or more other components of the first vehicle 110. For example, one or more measurements may be performed using the one or more first sensors 106 to determine at least a part of the one or more first vehicle measures. In an example, the one or more first vehicle measures may comprise one or more weather property measures, such as at least one of a barometric pressure measure (e.g., at least one of absolute barometric pressure, atmospheric barometric pressure, surface barometric pressure, etc.), a humidity measure, a temperature measure (e.g., ambient air temperature), etc. The barometric pressure measure, the humidity measure and/or the temperature measure may be determined using a barometric sensor, a humidity sensor and/or a temperature sensor of the one or more first sensors 106, respectively.

In some examples, the first vehicle device 108 may receive the one or more first vehicle measures from the one or more first sensors 106 and/or the one or more other components of the first vehicle 110. At least a part of the one or more first vehicle measures may be received (from the one or more first sensors 106 and/or the one or more other components) via a Controller Area Network bus (CAN bus) of the first vehicle 110.

In some examples, the first vehicle device 108 may be an electronic control unit (ECU) of the first vehicle 110. For example, a module (e.g., a program and/or a code module) may be installed on the ECU of the first vehicle 110 to enable the ECU to determine information (e.g., the one or more first vehicle measures and/or the first location) and/or transmit the first vehicle measure signal 104 to the weather system 102. In some examples, the module may be installed on the ECU during manufacture of the first vehicle 110 and/or during manufacture of the ECU. Alternatively and/or additionally, the module may be installed on the ECU (as an update, for example) after the vehicle 110 and/or the ECU are manufactured. The module may be installed on the ECU by an original equipment manufacturer (OEM) of the first vehicle 110 (or by another entity).

Alternatively and/or additionally, the first vehicle device 108 may be connected to an on-board diagnostics (OBD) port of the first vehicle 110, such as an OBD-II port of the first vehicle 110. For example, the first vehicle device 108 may be powered by the OBD port. Alternatively and/or additionally, the first vehicle device 108 may comprise a component (e.g., a universal asynchronous receiver-transmitter (UART), such as a serial UART) for communicating over the OBD port. The first vehicle device 108 may determine (e.g., collect) the first location and/or at least a part of the one or more first vehicle measures by communicating with one or more components of the first vehicle 110 and/or the CAN bus (using CAN bus protocol, for example). In an example, the first vehicle device 108 may determine the barometric pressure measure (e.g., at least one of absolute barometric pressure, atmospheric barometric pressure, surface barometric pressure, etc.) by sending a request via the OBD port (e.g., a Service 1, Parameter ID (PID) 0x33 request) and/or receiving an indication of the barometric pressure measure (e.g., a 1-byte response comprising the barometric pressure measure) via the OBD port.

Alternatively and/or additionally, the first location may be determined using a location determination component (comprising a satellite navigation signal receiver, for example) of the first vehicle 110 and/or the first vehicle device 108. The first vehicle device 108 may comprise the location determination component (and/or the location determination component may be part of the first vehicle device 108). Alternatively and/or additionally, the location determination component may be separate from (and/or not a part of) the first vehicle device 108. In some examples, the location determination component may receive a set of global navigation satellite system (GNSS) signals (e.g., a set of one or more GNSS signals). The set of GNSS signals may be received from a satellite navigation system, such as a GNSS (e.g., Global Positioning System (GPS), Global Navigation Satellite System (GLONASS), Galileo, etc.), where the first location may be determined based upon the set of GNSS signals. For example, the set of GNSS signals may be received from GNSS satellites of the satellite navigation system. Alternatively and/or additionally, for increased location accuracy, the location determination component may receive a set of corrective signals (e.g., a set of one or more corrective signals) and use the set of corrective signals (in conjunction with the set of GNSS signals, for example) to determine the first location. In some examples, the set of corrective signals may comprise one or more differential GNSS (DGNSS) signals (received from a DGNSS station with a fixed and/or known location, for example). Alternatively and/or additionally, the set of corrective signals may comprise one or more real-time kinematic (RTK) signals (received from an RTK station with a fixed and/or known location, for example). In some examples, the first location may be indicative of latitude, longitude and/or elevation.

In some examples, the first vehicle measure signal 104 may be transmitted (to the weather system 102, for example) using a communication component of the first vehicle 110 and/or the first vehicle device 108. The first vehicle device 108 may comprise the communication component (and/or the communication component may be part of the first vehicle device 108). Alternatively and/or additionally, the communication component may be separate from (and/or not a part of) the first vehicle device 108. In an example, the communication component may comprise a communication device (e.g., a wireless communication device) configured to transmit one or more signals (e.g., the first vehicle measure signal 104 and/or other vehicle measure signals) to the weather system 102 (e.g., to a computer of the weather system 102, such as in at least one of an edge, a cloud, etc.) via one or more types of communication media, such as at least one of communication media over a local area network (e.g., a wireless local area network and/or wired local area network, such as utilizing at least one of Ethernet, WiFi, or other technology), communication media utilizing one or more cellular network technologies (e.g., second-generation cellular technology (2G), third-generation cellular technology (3G), fourth-generation cellular technology (4G), fifth-generation cellular technology (5G) and/or one or more future generation cellular technologies and/or other types of wireless communication media), communication media over a wide area network, cable, optical fiber, radio, etc.

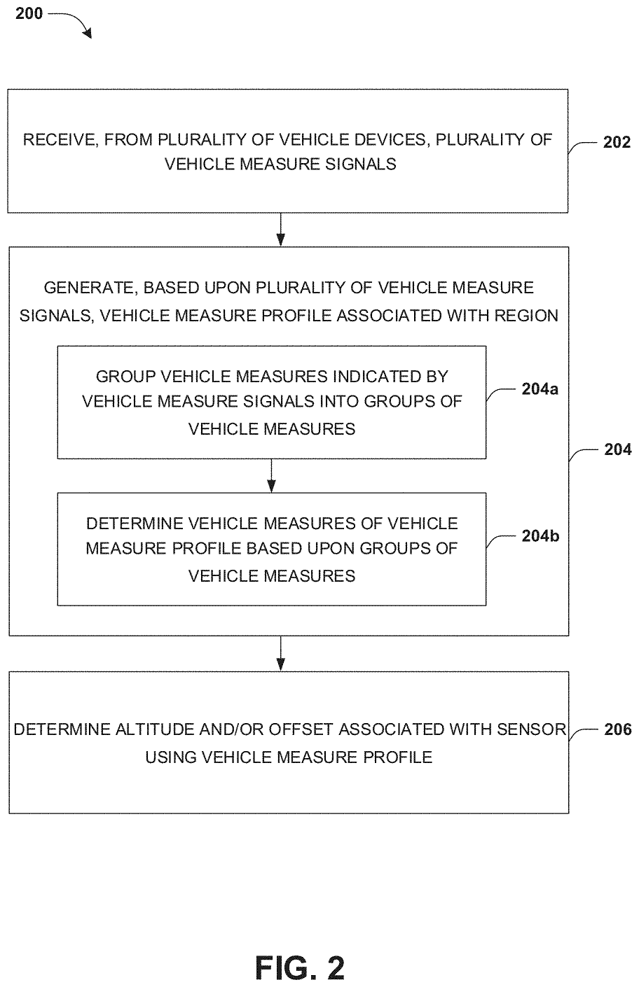

An embodiment for generating profiles, such as weather profiles, based upon signals from vehicle devices is illustrated by an exemplary method 200 of FIG. 2, and is further described in conjunction with the system 101 of FIGS. 1A-1F. At 202, a plurality of vehicle measure signals may be received from a plurality of vehicle devices. In an example, the plurality of vehicle measure signals may comprise the first vehicle measure signal 104 and/or the plurality of vehicle devices may comprise the first vehicle device 108. In some examples, the plurality of vehicle devices may be associated with a plurality of vehicles. For example, a vehicle device of the plurality of vehicle devices (and/or each vehicle device of the plurality of vehicle devices) may be connected to (and/or comprised in) a vehicle of the plurality of vehicles. In some examples, the plurality of vehicles may comprise at least one of one or more cars (such as shown in FIG. 1A), one or more trains, one or more buses, one or more tractors, one or more aircrafts, one or more unmanned aerial vehicles (e.g., one or more drones), etc. In some examples, a vehicle measure signal of the plurality of vehicle measure signals (and/or each vehicle measure signal of the plurality of vehicle measure signals) may be indicative of a location (such as the first location discussed with respect to the first vehicle measure signal 104) of a vehicle connected to (and/or comprising) a vehicle device from which the vehicle measure signal is received, one or more vehicle measures (such as the one or more first vehicle measures discussed with respect to the first vehicle measure signal 104) and/or a time (e.g., a time, such as a time of day, at which the vehicle measure signal is transmitted and/or at which one or more measurements are performed to determine the one or more vehicle measures). At least some of the plurality of vehicle measure signals may be anonymized (for privacy protection, for example).

At 204, a vehicle measure profile associated with a region may be generated based upon the plurality of vehicle measure signals. For example, the vehicle measure profile may be indicative of one or more vehicle measures at one or more locations within the region. The one or more vehicle measures at the one or more locations are determined based upon the plurality of vehicle measure signals (e.g., based upon vehicle measures indicated by the plurality of vehicle measure signals).

In some examples, the vehicle measure profile may comprise a weather profile associated with the region. The one or more vehicle measures at the one or more locations may comprise one or more weather property measures (e.g., measures of a weather property) at the one or more locations, wherein the one or more weather property measures at the one or more locations are determined based upon the plurality of vehicle measure signals (e.g., based upon weather property measures indicated by the plurality of vehicle measure signals).

For example, the vehicle measure profile may comprise a barometric pressure profile associated with the region. The one or more vehicle measures at the one or more locations may comprise one or more barometric pressure measures (e.g., measures of barometric pressure) at the one or more locations, wherein the one or more barometric pressure measures at the one or more locations are determined based upon the plurality of vehicle measure signals (e.g., based upon barometric pressure measures indicated by the plurality of vehicle measure signals).

Alternatively and/or additionally, the vehicle measure profile may comprise a humidity profile associated with the region. The one or more vehicle measures at the one or more locations may comprise one or more humidity measures (e.g., measures of humidity) at the one or more locations, wherein the one or more humidity measures at the one or more locations are determined based upon the plurality of vehicle measure signals (e.g., based upon humidity measures indicated by the plurality of vehicle measure signals).

Alternatively and/or additionally, the vehicle measure profile may comprise a temperature profile associated with the region. The one or more vehicle measures at the one or more locations may comprise one or more temperature measures (e.g., measures of temperature) at the one or more locations, wherein the one or more temperature measures at the one or more locations are determined based upon the plurality of vehicle measure signals (e.g., based upon temperature measures indicated by the plurality of vehicle measure signals).

In some examples, at least some vehicle measures, based upon which the vehicle measure profile is generated, may be filtered and/or adjusted by one or more vehicle devices of the plurality of vehicle devices and/or by the weather system 102. For example, a vehicle measure (e.g., at least one of a barometric pressure measure, a humidity measure, a temperature measure, etc.) determined using a sensor (e.g., at least one of a barometric sensor, a humidity sensor, a temperature sensor, etc.) of the one or more first sensors 106 may be filtered and/or adjusted based upon at least one of a speed of the first vehicle 110, an engine temperature of the first vehicle 110, etc. For example, the vehicle measure may be filtered and/or adjusted to normalize the vehicle measure for generation of the vehicle measure profile and/or for comparison to vehicle measures obtained from other vehicles (other than the first vehicle 110) of the plurality of vehicles.

In an example, the vehicle measure profile may be indicative of a first profile-indicated vehicle measure at a first profile-indicated location within the region. For example, the first profile-indicated vehicle measure may be a weather property measure (e.g., at least one of a barometric pressure measure, a humidity measure, a temperature measure, etc.) at the first profile-indicated location. In some examples, the first profile-indicated vehicle measure may be determined based upon one or more vehicle measures indicated by one or more vehicle measure signals of the plurality of vehicle measure signals and/or the first profile-indicated location may be determined based upon one or more locations associated with the one or more vehicle measures.

In some examples, the first profile-indicated location may correspond to a point (e.g., a geographical point) within the region, wherein the first profile-indicated vehicle measure is a vehicle measure (e.g., weather property measure) applicable to the point (e.g., the first profile-indicated vehicle measure is reflective and/or representative of a condition, such as a weather condition and/or an environmental condition, at the point). In an example in which the first profile-indicated vehicle measure is a barometric pressure measure, the vehicle measure profile indicates that a barometric pressure of the point (e.g., the geographical point) is the barometric pressure measure.

Alternatively and/or additionally, the first profile-indicated location may correspond to an area (e.g., a geographical area) within the region, wherein the first profile-indicated vehicle measure is a vehicle measure (e.g., weather property measure) applicable to the area (e.g., the first profile-indicated vehicle measure is reflective of a condition, such as a weather condition and/or an environmental condition, in the area). In an example in which the first profile-indicated vehicle measure is a barometric pressure measure, the vehicle measure profile indicates that a barometric pressure in the area (e.g., the geographical point) is the barometric pressure measure.

In some examples, the vehicle measure profile may be generated by grouping (e.g., clustering), at 204a, at least some vehicle measures indicated by the plurality of vehicle measures into groups of vehicle measures and/or determining, at 204b, vehicle measures of the vehicle measure profile based upon the groups of vehicle measures. In some examples, the first profile-indicated vehicle measure may be determined based upon a first group of vehicle measures (e.g., a group of barometric pressure measures), of the groups of vehicle measures, indicated by a first group of vehicle measure signals of the plurality of vehicle measure signals. For example, vehicle measures indicated by the plurality of measure signals may be grouped into the groups of vehicle measures based upon locations associated with the vehicle measures and/or times associated with the vehicle measures, wherein a first group of vehicle measures of the groups of vehicle measures may be used to determine the first profile-indicated vehicle measure, a second group of vehicle measures of the groups of vehicle measures may be used to determine a second profile-indicated vehicle measure of the vehicle measure profile, etc. In an example, vehicle measures may be included in the first group of vehicle measures based upon distances (e.g., geographic distances) between locations associated with the first group of vehicle measures (e.g., based upon a determination that the locations associated with the first group of vehicle measures are within a threshold distance from each other). Alternatively and/or additionally, vehicle measures may be included in the first group of vehicle measures based upon a determination that the locations associated with the first group of vehicle measures are within an area of the region (wherein the area may not exceed a threshold size and/or a threshold geographic range, for example).

In an example with respect to FIG. 1B, the first group of vehicle measures may comprise the first vehicle measure (shown with reference number M1), a second vehicle measure M2 and a third vehicle measure M3. The first vehicle measure M1 may be determined based upon the first vehicle measure signal 104 transmitted by the first vehicle device 108 connected to the first vehicle 110, wherein the first vehicle measure signal 104 may be indicative of the first location (shown with reference number 122) and/or the first time. The second vehicle measure M2 may be determined based upon a second vehicle measure signal transmitted by a second vehicle device connected to a second vehicle 116, wherein the second vehicle measure signal may be indicative of a second location 118 (e.g., a location of the second vehicle 116) and/or a second time. For example, the second time may correspond to a time, such as a time of day, at which the second vehicle measure signal is transmitted and/or at which a measurement is performed to determine the second vehicle measure M2. The third vehicle measure M3 may be determined based upon a third vehicle measure signal transmitted by a third vehicle device connected to a third vehicle 124, wherein the third vehicle measure signal may be indicative of a third location 126 (e.g., a location of the third vehicle 124) and/or a third time. For example, the third time may correspond to a time, such as a time of day, at which the third vehicle measure signal is transmitted and/or at which a measurement is performed to determine the third vehicle measure M3.

In some examples, the vehicle measures M1, M2 and M3 may be included in (e.g., grouped into) the first group of vehicle measures based upon locations associated with the vehicle measures M1, M2 and M3 (e.g., the locations comprise the first location 122, the second location 118, and/or the third location 126). For example, the vehicle measures M1, M2 and M3 may be included in (e.g., grouped into) the first group of vehicle measures based upon a determination that the locations are within a threshold distance from each other. Alternatively and/or additionally, the vehicle measures M1, M2 and M3 may be included in (e.g., grouped into) the first group of vehicle measures based upon a determination that the locations are within an area 120 of the region (wherein the area 120 may not exceed a threshold size and/or a threshold geographic range, for example).

Alternatively and/or additionally, the vehicle measures M1, M2 and M3 may be included in (e.g., grouped into) the first group of vehicle measures based upon times associated with the vehicle measures M1, M2 and M3 (e.g., the times comprise the first time, the second time, and/or the third time). For example, the vehicle measures M1, M2 and M3 may be included in (e.g., grouped into) the first group of vehicle measures based upon a determination that the times are within a time period (e.g., a time range). Alternatively and/or additionally, the vehicle measures M1, M2 and M3 may be included in (e.g., grouped into) the first group of vehicle measures based upon a determination that the times are within a threshold duration of time from a current time. In an example, the current time may be 4:00 PM and the threshold duration of time may be 15 minutes. Accordingly, the vehicle measures M1, M2 and M3 may be included in the first group of vehicle measures based upon a determination that each of the times is 3:45 PM or later.

In some examples, the first profile-indicated vehicle measure and/or the first profile-indicated location may be determined based upon the first group of vehicle measures (e.g., vehicle measures M1, M2 and M3) and/or the locations associated with the vehicle measures M1, M2 and M3.

In some examples, the first profile-indicated location may be determined based upon the locations (e.g., the locations comprise the first location 122, the second location 118, and/or the third location 126). In an example in which the first profile-indicated location corresponds to a point (e.g., a geographical point), the first profile-indicated location may be a centroid 128 of the locations. In an example in which the first profile-indicated location is the centroid 128 of the locations, at least one of longitude of the first profile-indicated location is a combination (e.g., an average) of longitudes of the locations, latitude of the first profile-indicated location is a combination (e.g., an average) of latitudes of the locations, etc. Alternatively and/or additionally, in an example in which the first profile-indicated location is the centroid 128 of the locations, the first profile-indicated location may be determined by clustering the locations. In an example in which the first profile-indicated location corresponds to an area (e.g., a geographical area), the first profile-indicated location may be a first area (e.g., the area 120 or a different area), such as where the locations are within the first area and/or the first area does not exceed a threshold size and/or a threshold geographic range.

In some examples, the first profile-indicated vehicle measure may be determined based upon the first group of vehicle measures (e.g., vehicle measures M1, M2 and M3). For example, one or more operations (e.g., mathematical operations) may be performed using the vehicle measures M1, M2 and M3 to determine the first profile-indicated vehicle measure. In an example, the vehicle measures M1, M2 and M3 may be combined (e.g., averaged) to determine the first profile-indicated vehicle measure.

In some examples, the first vehicle measure profile may be determined based upon error levels associated with vehicle measures indicated by the plurality of vehicle measure signals. For example, the first profile-indicated vehicle measure may be determined based upon one or more error levels associated with the first group of vehicle measures (e.g., vehicle measures M1, M2 and M3). For example, the one or more error levels may comprise a first error level associated with the first vehicle measure M1, a second error level associated with the second vehicle measure M2 and/or a third error level associated with the third vehicle measure M3. In some examples, an error level of the one or more error levels may correspond to (and/or be determined based upon) a variance, an accuracy and/or precision of a sensor. In some examples, the first error level may be an error level associated with a first sensor, of the one or more first sensors 106 of the first vehicle 110, used to determine the first vehicle measure M1. The second error level may be an error associated with a second sensor, of the second vehicle 116, used to determine the second vehicle measure M2. Alternatively and/or additionally, the third error level may be an error associated with a third sensor, of the third vehicle 116, used to determine the third vehicle measure M3. In some examples, an error level of the one or more error levels may be determined based upon a vehicle measure signal. For example, the first vehicle measure signal 104 may be indicative of the first error level (associated with the first vehicle measure M1 and/or the first sensor), and/or the first error level may be determined based upon the first vehicle measure signal 104. Alternatively and/or additionally, an error level of the one or more error levels may be determined based upon sensor error information (stored in a data store, for example) indicative of error levels associated with sensors and/or vehicles. In an example, the sensor error information may be accessed and/or analyzed based upon vehicle identification information associated with the first vehicle 110 and/or sensor identification information associated with the first sensor to identify an indication (in the sensor error information) that the first sensor is associated with the first error level. In an example, the vehicle identification information may comprise a manufacturer and/or a model of the first vehicle 100. For example, the first error level may be determined based upon an indication, in the sensor error information, that sensors of vehicles having the manufacturer and/or the model have the first error level. Alternatively and/or additionally, the sensor identification information may comprise a sensor identification of the first sensor. For example, the first error level may be determined based upon an indication, in the sensor error information, that a sensor corresponding to the sensor identification has the first error level. In some examples, the vehicle identification information and/or the sensor identification information may be determined based upon the first vehicle measure signal 104 (e.g., the first vehicle measure signal 104 may be indicative of the vehicle identification information and/or the sensor identification information).

In some examples, one or more weights associated with the first group of vehicle measures (e.g., vehicle measures M1, M2 and M3) may be determined based upon the one or more error levels. For example, the one or more weights may comprise a first weight associated with the first vehicle measure M1, a second weight associated with the second vehicle measure M2 and/or a third weight associated with the third vehicle measure M3. The first profile-indicated vehicle measure may be determined based upon the one or more weights. For example, the one or more weights may be applied to the vehicle measures M1, M2 and M3 for determining the first profile-indicated vehicle measure (e.g., the first weight may be applied to the first vehicle measure M1, the second weight may be applied to the second vehicle measure M2 and/or the third weight may be applied to the third vehicle measure M3). In an example, the first weight may be greater than the second weight if the second error level is greater than the first error level, such as where an accuracy of the first sensor of the first vehicle 110 exceeds an accuracy of a sensor, of the second vehicle, that is used to measure and/or determine the second vehicle measure M2. For example, the first vehicle measure M1 may have a greater contribution than the second vehicle measure M2 in determining the first profile-indicated vehicle measure if the second error level associated with the second vehicle measure M2 is greater than the first error level associated with the first vehicle measure M1.

It may be appreciated that by determining the first profile-indicated vehicle measure and/or the first profile-indicated location based upon the first group of vehicle measures (e.g., vehicle measures M1, M2 and M3) and/or the one or more error levels, the first profile-indicated vehicle measure of the vehicle measure profile may be more accurate as compared to determining the first profile-indicated vehicle measure based upon a single vehicle measure and/or without accounting for error levels of sensors. For example, using the first group of vehicle measures to determine the first profile-indicated vehicle measure (as compared to using merely a single vehicle measure determined using a single sensor of a vehicle, for example) and/or using the one or more error levels to determine the first profile-indicated vehicle measure may compensate errors and/or shifts associated with sensor measurements.

In some examples, confidence intervals may be assigned to vehicle measures (e.g., weather property measures) indicated by the vehicle measure profile (e.g., the vehicle measure profile may be indicative of the confidence intervals associated with the vehicle measures). In an example, a first confidence interval of the confidence intervals may be assigned to the first profile-indicated vehicle measure. The first confidence interval may be determined based upon at least one of the one or more error levels (e.g., a higher error level of the one or more error levels may correspond to a wider and/or less precise confidence interval), a quantity of vehicle measures of the first group of vehicle measures (e.g., a higher quantity of vehicle measures may correspond to a narrower and/or more precise confidence interval), etc.

In some examples, previously determined and/or measured vehicle measures may be converted to current vehicle measures, wherein the vehicle measure profile may be generated based upon the current vehicle measures. It may be appreciated that by converting previously determined and/or measured vehicle measures to current vehicle measures and/or using the current vehicle measures to generate the vehicle measure profile, vehicle measures (e.g., weather property measures) of the vehicle measure profile may have increased granularity and/or accuracy (such as due to more usable information being utilized to generate the vehicle measure profile as compared to merely utilizing vehicle measures that are measured, determined and/or received within the time period).

In an example, the first time associated with the first vehicle measure M1 may be a time T1. A fourth vehicle measure associated with a time T2 (e.g., a time after the time T1, such as a current time and/or a time within the time period) may be determined based upon the first vehicle measure M1 (e.g., the first vehicle measure M1 associated with the time T1 may be converted to the fourth vehicle measure associated with the time T2). The vehicle measure profile may be determined based upon the fourth vehicle measure (e.g., the first profile-indicated vehicle measure may be determined based upon the fourth vehicle measure). In some examples, the fourth vehicle measure may be representative of a vehicle measure at the time T2. In an example in which the first vehicle measure M1 is a barometric pressure measure determined and/or measured at the time T1, the fourth vehicle measure may be representative of a barometric pressure measure at the first location 122 (and/or in the area 120 associated with the first group of vehicle measures) at the time T2.

In some examples, the fourth vehicle measure may be determined based upon weather property information received from one or more weather information provider devices (e.g., one or more devices configured to provide weather property information to one or more devices). The weather property information may be indicative of weather property measures (e.g., the weather property measures may be determined and/or measured by one or more weather stations).

In an example with respect to FIG. 10, the weather property information may be indicative of first weather property information comprising one or more first weather property measures determined and/or measured by a first weather station 130 from the time T1 to the time T2, second weather property information comprising one or more second weather property measures determined and/or measured by a second weather station 132 from the time T1 to the time T2 and/or third weather property information comprising one or more third weather property measures determined and/or measured by a third weather station 134 from the time T1 to the time T2. In some examples, a set of weather property measures 136 at the first location 122 (and/or in the area 120 associated with the first group of vehicle measures) from the time T1 to the time T2 may be determined based upon the weather property information (e.g., the set of weather property measures 136 may be determined based upon the one or more first weather property measures determined and/or measured by the first weather station 130, the one or more second weather property measures determined and/or measured by the second weather station 132 and/or the one or more third weather property measures determined and/or measured by the third weather station 134). In some examples, the set of weather property measures 136 may be determined based upon one or more locations associated with the one or more first weather property measures, the one or more second weather property measures and/or the one or more third weather property measures. For examples, the set of weather property measures 136 may be determined based upon a first measure location at which the one or more first weather property measures are determined and/or measured, a second measure location at which the one or more second weather property measures are determined and/or measured and/or a third measure location at which the one or more first weather property measures are determined and/or measured. In an example, the first measure location may correspond to a location of the first weather station, the second measure location may correspond to a location of the second weather station and/or the third measure location may correspond to a location of the third weather station.

In some examples, a weather property measure of the one or more first weather property measures, a weather property measure of the one or more second weather property measures and/or a weather property measure of the one or more third weather property measures may be used (such as using one or more triangulation techniques), based upon the one or more locations, to determine (e.g., interpolate) a weather property measure at the first location 122 (and/or in the area 120 associated with the first group of vehicle measures), wherein the set of weather property measures 136 may be indicative of the determined weather property measure. For example, a weather property measure measured and/or determined by the first weather station 130 at the time T1, a weather property measure measured and/or determined by the second weather station 132 at the time T1 and/or a weather property measure measured and/or determined by the third weather station 134 at the time T1 may be used (such as using one or more triangulation techniques), based upon the one or more locations, to determine (e.g., interpolate) a weather property measure 131 at the first location 122 (and/or in the area 120 associated with the first group of vehicle measures) and/or at the time T1. Alternatively and/or additionally, a weather property measure measured and/or determined by the first weather station 130 at the time T2, a weather property measure measured and/or determined by the second weather station 132 at the time T2 and/or a weather property measure measured and/or determined by the third weather station 134 at the time T2 may be used (such as using one or more triangulation techniques), based upon the one or more locations, to determine (e.g., interpolate) a weather property measure 133 at the first location 122 (and/or in the area 120 associated with the first group of vehicle measures) and/or at the time T2. The set of weather property measures 136 may comprise the weather property measure 131 associated with the time T1 and/or the weather property measure 133 associated with the time T2. In some examples, one or more other weather property measures, that are at the first location 122 (and/or in the area 120 associated with the first group of vehicle measures) and are associated with one or more times between the time T1 and the time T2, may be determined (such as using one or more of the techniques provided herein with respect to determining the weather property measure 131 and/or the weather property measure 133). The set of weather property measures 136 may comprise the one or more other weather property measures.

In some examples, the first vehicle measure M1 associated with the time T1 may be modified to determine the fourth vehicle measure based upon the set of weather property measures 136, such as based upon the weather property measure 131 associated with the time T1 and the weather property measure 133 associated with the time T2. For example, a difference between the weather property measure 131 and the weather property measure 133 may be determined. The fourth vehicle measure may be determined based upon the first vehicle measure M1 and the difference. In an example in which the weather property measure 131 is higher than the weather property measure 133 (such as where the weather property decreases at the first location 122 and/or in the area 120 from the time T1 to the time T2), the first vehicle measure M1 may be subtracted by the difference to determine the fourth vehicle measure. In an example in which the weather property measure 131 is lower than the weather property measure 133 (such as where the weather property increases at the first location 122 and/or in the area 120 from the time T1 to the time T2), the first vehicle measure M1 may be summed with the difference to determine the fourth vehicle measure.

Alternatively and/or additionally, a change (e.g., a percentage change, such as a percentage increase and/or a percentage decrease) from the weather property measure 131 associated with the time T1 to the weather property measure 133 associated with the time T2 may be determined. In an example in which the weather property measure 133 is double the weather property measure 131, the change may be indicative of a 100% increase. The fourth vehicle measure may be determined based upon the first vehicle measure M1 and the change. For example, the first vehicle measure M1 may be increased or decreased, according to the change, to determine the fourth vehicle measure associated with the time T2. For example, if the change is indicative of a 100% increase, the fourth vehicle measure may be double the first vehicle measure M1.

In the example shown in FIG. 10, the weather property measure 133 is lower than the weather property measure 131, and thus the first vehicle measure M1 may be reduced to determine the fourth vehicle measure (e.g., the first vehicle measure M1 may be reduced by the difference and/or the change to determine the fourth vehicle measure).

In an example in which the fourth vehicle measure is determined based upon the first vehicle measure M1, the vehicle measure profile may be generated based upon the fourth vehicle measure (and/or the first profile-indicated vehicle measure may be determined based upon the fourth vehicle measure). Alternatively and/or additionally, in an example in which the fourth vehicle measure is included in the first group of vehicle measures (such as where the time T2 is within the time period associated with the first group of vehicle measures and/or the time T1 is not within the time period associated with the first group of vehicle measures), the first group of vehicle measures may comprise the fourth vehicle measure (and/or may not comprise the first vehicle measure M1). In an example, the first profile-indicated vehicle measure may be determined based upon the first group of vehicle measures comprising the fourth vehicle measure, the second vehicle measure M2 and the third vehicle measure M3 (such as using one or more of the techniques provided herein with respect to determining the first profile-indicated vehicle measure based upon the first vehicle measure M1, the second vehicle measure M2 and the third vehicle measure M3).

In an example in which the vehicle measure profile comprises the barometric pressure profile associated with the region, the weather property information (e.g., the first weather property information, the second weather property information and/or the third weather property information) may comprise barometric pressure information. The one or more first weather property measures may comprise one or more first barometric pressure measures from the time T1 to the time T2, the one or more second weather property measures may comprise one or more second barometric pressure measures from the time T1 to the time T2 and/or the one or more third weather property measures may comprise one or more third barometric pressure measures from the time T1 to the time T2. The set of weather property measures 136 may comprise a set of barometric pressure measures 136 determined based upon the one or more first barometric pressure measures, the one or more second barometric pressure measures, and/or the one or more third barometric pressure measures. For example, the weather property measure 131 may comprise a barometric pressure measure 131 associated with the time T1 and/or the weather property measure 133 may comprise a barometric pressure measure 133 associated with the time T2. The first vehicle measure M1 may comprise a first barometric pressure measure M1 and/or the fourth vehicle measure may comprise a fourth barometric pressure measure, wherein the fourth barometric pressure measure may be determined based upon the first barometric pressure measure M1 and/or the set of barometric pressure measures 136, such as based upon the difference between the barometric pressure measure 131 and the barometric pressure measure 133 and/or based upon the change from the barometric pressure measure 131 to the barometric pressure measure 133.

In some examples, a vehicle measure indicated by the vehicle measure profile may be associated with a location within the region. For example, the vehicle measure indicated by the vehicle measure profile may be associated with a point (e.g., a geographical point) and/or an area (e.g., a geographical area) within the region.

In some examples, the vehicle measure profile may comprise a map of vehicle measures at locations of the region. In an example, the first map of vehicle measures may be a map of weather property measures, such as at least one of a map of barometric pressure measures, a map of humidity measures, a map of temperature measures, etc.

In some examples, the vehicle measure profile may be used to determine a vehicle measure (e.g., a weather property measure) associated with a location within the region. For example, the vehicle measure profile may be analyzed based upon the location to determine the vehicle measure. In some examples, the vehicle measure may be determined based upon an indication, in the vehicle measure profile, that the location is within an area associated with the vehicle measure (and/or based upon an indication, in the vehicle measure profile, that the location is associated with the vehicle measure). In an example in which the vehicle measure is a barometric pressure measure, the barometric pressure measure may be determined based upon an indication in the vehicle measure profile, that a barometric pressure of an area comprising the location is the barometric pressure measure (and/or based upon an indication, in the vehicle measure profile, that a barometric pressure of the location is the barometric pressure measure).

In some examples, such as where the vehicle measure profile comprises a weather profile, the vehicle measure profile may be used to determine a reference value (e.g., a reference barometric pressure measure, a reference humidity measure, a reference temperature sensor, etc.) for calibrating a sensor (e.g., a barometric sensor, a humidity sensor, a temperature sensor, etc.). FIG. 1D illustrates a reference value 142 (e.g., a reference barometric pressure measure) being determined based upon a location 136 of a sensor to be calibrated. In an example, the location 136 may be input to a reference value determiner 140. The reference value determiner may use the vehicle measure profile (shown with reference number 138) to determine the reference value 142 associated with the location 136. In an example, the vehicle measure profile may indicate that a barometric pressure measure at the location 136 is 1002.10 millibars (mbar). For example, the vehicle measure profile may indicate that a barometric pressure of a barometric pressure measure of an area 137 comprising the location 136 is 1002.10 mbar. Accordingly, the reference value 142 associated with the location 136 may be determined to be 1002.10 mbar.

In some examples, at 206, an altitude (e.g., a device altitude 162 shown in FIG. 1F) and/or an offset (e.g., the offset 148 shown in FIG. 1E) associated with a sensor (e.g., a barometric sensor) may be determined using the vehicle measure profile. For example, the offset associated with the sensor may be determined based upon the reference value 142 and a weather property measure (e.g., a barometric pressure measure) determined by performing a measurement (e.g., a barometric measurement) using the sensor. In some examples, the offset may be used for calibration of the sensor. For example, the weather property measure may be determined, using the sensor, when the sensor is at the location 136. In some examples, the location 136 and/or the weather property measure may be received (by the weather system 102, for example) from a device comprising and/or connected to the sensor.

FIG. 1E illustrates an exemplary scenario in which the offset (shown with reference number 148) is determined. For example, the reference value 142 and/or the weather property measure (shown with reference number 150) determined using the sensor may be input to an offset determiner 146 (e.g., a barometric offset determiner). The offset determiner 146 may determine the offset 148 based upon the reference value 142 and/or the weather property measure 150 determined using the sensor.

In some examples, the offset 148 (e.g., the barometric offset) may be used to adjust and/or correct subsequently determined measures measured using the sensor (e.g., the offset 148 may be used to adjust and/or correct subsequently determined barometric pressure measures measured using the barometric sensor). For example, a second measurement (e.g., barometric measurement) may be performed using the sensor to determine a second weather property measure (e.g., a barometric pressure measure). In some examples, an adjusted weather property measure (e.g., an adjusted barometric pressure measure) may be determined based upon the second weather property measure and the offset 148. For example, the adjusted weather property measure may correspond to a corrected weather property measure that takes the offset 148 (associated with an error of measurement of the sensor, for example) into account. In some examples, one or more operations (e.g., mathematical operations) may be performed using the second weather property measure and the offset 148 to determine the adjusted weather property measure. For example, the offset 148 may be at least one of added to, subtracted from, multiplied by, etc. the second weather property measure to determine the adjusted weather property measure. In an example in which the adjusted weather property measure is the adjusted barometric pressure measure, the altitude of the sensor may be determined using the adjusted barometric pressure measure.

In some examples, the sensor (e.g., the barometric sensor) is comprised in and/or connected to a device 160 (e.g., a tracking device, an Internet of Things (IoT) device, a client device, a User Equipment (UE), a phone, a laptop, a computer, a wearable device, a smart device, a television, any other type of computing device, hardware, etc.). In some examples, the device 160 may transmit, to the weather system 102, the adjusted barometric pressure measure determined using the sensor and/or a location of the device 160. The weather system 102 may determine a device altitude 162 of the device 160 based upon the adjusted barometric pressure measure, the location of the device 160 and/or the vehicle measure profile (e.g., the barometric pressure profile).

FIG. 1F illustrates an exemplary scenario in which the device altitude 162 of the device 160 is determined based upon the adjusted barometric pressure measure (shown with reference number 158) and/or a reference barometric pressure measure 170. In some examples, the reference barometric pressure measure 170 may be determined based upon the location of the device 160 and the vehicle measure profile (e.g., barometric pressure profile), such as using one or more of the techniques provided herein with respect to determining the reference value 142. For example, the vehicle measure profile may indicate that a barometric pressure (e.g., outdoor barometric pressure) of the location of the device 160 is the reference barometric pressure measure 170. A barometric pressure value 168 (e.g., indoor and/or ground level barometric pressure) may be determined based upon the reference barometric pressure measure 170, a first temperature 164 (e.g., an outdoor temperature associated with the location of the device 160) and/or a second temperature 166. The second temperature 166 may be an indoor temperature, such as a temperature within a building 156 (within which the device 160 is located). The second temperature 166 may be determined using a temperature sensor. Alternatively and/or additionally, the second temperature 166 may be set to an indoor temperature that is stored on the device 160 (e.g., at least one of a device measured temperature, a standard indoor temperature, a standard room temperature, an expected temperature between about 68° Fahrenheit to about 72° Fahrenheit, etc.). The barometric pressure value 168 may be determined based upon the reference barometric pressure measure 170 and/or a temperature difference between outside the building 156 and inside the building 156 (e.g., the temperature difference may be determined based upon the first temperature 164 and the second temperature 166). In some examples, the device altitude 162 may be determined based upon the adjusted barometric pressure measure 158 and/or the barometric pressure value 168. In some examples, the device altitude 162 may correspond to at least one of a height of the device 160, an elevation of the device 160, a vertical distance between the device 160 and a reference point, etc. In an example, the reference point may correspond to at least one of ground level 172, surface level, sea level, a location corresponding to the barometric pressure value 168, etc.

In some examples, the device altitude 162 may be determined by the device 160. For example, the weather system 102 may provide the device 160 with the vehicle measure profile (e.g., the barometric pressure profile), the reference barometric pressure measure 170 and/or other information to enable the device 160 to determine the device altitude 162.

In some examples, the device altitude 162 may be determined by the weather system 102. For example, the device 160 may provide the weather system 102 with the adjusted barometric pressure measure 158, the location of the device 160 and/or other information to enable the weather system 102 to determine the device altitude 162.

In some examples, the weather system 102 may store and/or determine the device altitude 162 of the device 160 for use by other systems and/or applications (some of which are described below). Alternatively or additionally, in some examples, the weather system 102 may determine a floor (of the building 156, for example) that the device 160 is located on, based upon the device altitude 162, the location of the device 160 and/or the adjusted barometric pressure measure 158, for use by the device 160, other systems and/or applications (some of which are described below). For example, the weather system 102 may determine the building 156 within which the device 160 is located based upon the location of the device 160. Alternatively and/or additionally, the weather system 102 may access building information (e.g., a blueprint, structural information, etc.) associated with the building 156. The weather system 102 may determine the floor based upon the building information and/or the device altitude 162 (and/or the adjusted barometric pressure measure 158).

In some examples, the weather system 102 may track a location of the device 160 and/or the floor on which the device 160 is located. In some examples, the weather system 102 may determine locating information based upon the device altitude 162, the location of the device 160 and/or the adjusted barometric pressure measure 158. For example, the locating information may be indicative of the floor. Alternatively and/or additionally, the locating information may be indicative of a location, within the floor, at which the device 160 is located. For example, the locating information may comprise a representation of the floor (such as a floor map showing boundaries of one or more areas, such as one or more rooms and/or units of the floor), wherein the representation of the floor comprises an indication of the location of the device 160.

In some examples, the weather system 102 may provide the locating information via an interface, such as an application programming interface (API) and/or a graphical user interface (GUI) to allow for information display. The locating information may be used to determine the device altitude 162 at which the device 160 is located, the floor on which the device 160 is located and/or a part of the floor (e.g., a room, a section and/or a unit of the floor) in which the device 160 is located.

In some examples, such as where the device 160 is coupled to an item, the locating information may be used to determine the device altitude 162, the floor and/or the part of the floor to locate the item. For example, the item may be located and/or retrieved using the locating information.

Alternatively and/or additionally, in some examples, such as where the device 160 belongs to and/or is carried and/or used by a person, the locating information may be used to determine the device altitude 162, the floor and/or the part of the floor to locate the person. For example, the person may be located using the locating information. In some examples, the locating information may be used by one or more entities, such as at least one of one or more guardians of the person, one or more users having authorization to the locating information, one or more first responders, etc.

In an example, the one or more first responders may use the locating information to locate the person and/or perform a rescue operation, such as where an emergency associated with the person is identified. The one or more first responders may be provided with the locating information, and/or may use the locating information to perform the rescue operation. In some examples, the weather system 102 may transmit the locating information to a first responder management device, according to some embodiments. In some examples, the first responder management device may provide one or more first responders (and/or one or more devices associated with the one or more first responders) with the locating information such that the one or more first responders can perform the rescue operation, such as by assisting the person (and/or one or more other people) on the floor (such as where the person and/or the one or more other people are trapped on the floor). Alternatively and/or additionally, the weather system 102 may generate and/or transmit instructions to the device 160. The instructions may be indicative of actions the person may take for safety. Alternatively and/or additionally, the instructions may be indicative of at least one directions for exiting the building, directions to one or more first responders that may assist the person, at least some of the locating information, etc.

In some examples, the second barometric measurement may be performed, the adjusted barometric pressure measure 158 and/or the device altitude 162 may be determined (and/or the device altitude 162, the location of the device 160 and/or the adjusted barometric pressure measure 158 may be transmitted to the weather system 102) in response to a trigger event. In some examples, the trigger event may comprise receiving a request for the device altitude 162, the location of the device 160 and/or the adjusted barometric pressure measure 158 (from the weather system 102 and/or other system, for example). Alternatively and/or additionally, the trigger event may comprise receiving a request for the device altitude 162 and/or the locating information via an interface (e.g., at least one of an API, a GUI, etc.) of the device 160 and/or other device. For example, in response to the request for the device altitude 162 and/or the locating information, the device altitude 162 and/or the locating information may be determined and/or provided via the interface. Alternatively and/or additionally, in response to the request for the device altitude 162 and/or the locating information, the device altitude 162 and/or the locating information may be determined (and/or provided via the interface) for use by the device 160, other systems and/or applications. Alternatively and/or additionally, the trigger event may correspond to an emergency event (such as an event in which a rescue operation may be performed to assist the person and/or one or more other people) detected by the device 160 and/or the weather system 102. In an example, the emergency event may be detected based upon an input received via the device 160, such as one or more selections of one or more selectable inputs corresponding to the emergency event, a call (e.g., at least one of a telephone call, a video call, a (Voice Over Internet Protocol) call, etc.) being placed to an emergency service (e.g., 911, enhanced 911 and/or other emergency service), a message being sent to an emergency service, etc.

In some examples, the device 160 may have one or more functionalities, one or more computing programs and/or data of the weather system 102. Alternatively and/or additionally, the weather system 102 may be implemented by the device 160. Alternatively and/or additionally, some and/or all operations performed by the weather system 102 as provided herein may be performed by the device 160, in accordance with some embodiments. Alternatively and/or additionally, some and/or all operations performed by the device 160 as provided herein may be performed by the weather system 102, in accordance with some embodiments.

In some examples, the one or more first vehicle measures in the first vehicle measure signal 104 (and/or other vehicle measures in other vehicle measure signals of the plurality of vehicle measure signals) may comprise at least one of vehicle speed (e.g., speed of the vehicle), O2 Sensor (Wide Range), O2 Sensor Data, fuel system status, calculated engine load, engine coolant temperature, engine coolant temperature, fuel trim information, Fuel pressure (and/or gauge pressure), intake manifold absolute pressure, engine speed, intake air temperature, mass air flow sensor (MAF) air flow rate, commanded secondary air status, oxygen sensor voltage and/or short term fuel trim, run time since engine start, fuel rail pressure (relative to manifold vacuum, for example), fuel rail gauge pressure (diesel, or gasoline direct injection), oxygen sensor air-fuel equivalence ratio, commanded evaporative purge, fuel tank level input, distance traveled since codes cleared, absolute barometric pressure, catalyst temperature, absolute load value, commanded air-fuel equivalence ratio, ambient air temperature, Evaporative Emission Control (EVAP) system vapor pressure, fuel rail absolute pressure, engine oil temperature, mass air flow sensor measure, engine coolant temperature, intake air temperature sensor, exhaust gas recirculation temperature, fuel pressure control system, injection pressure control system, turbocharger compressor inlet pressure, boost pressure control, exhaust pressure, turbocharger temperature, charge air cooler temperature (CACT), exhaust gas temperature (EGT), diesel particulate filter (DPF) temperature, NOx sensor measure, manifold surface temperature, particulate matter (PM) sensor, O2 Sensor measure, PM Sensor measure, exhaust gas temperature sensor, O2 Sensor Monitor, etc.

According to some embodiments, a method is provided. The method includes receiving, from a plurality of vehicle devices, a plurality of barometric pressure signals, wherein a first barometric pressure signal of the plurality of barometric pressure signals is received from a first vehicle device, of the plurality of vehicle devices, connected to a first vehicle, and wherein the first barometric pressure signal is indicative of a first location of the first vehicle and one or more first barometric pressure measures determined using a first barometric sensor of the first vehicle; and generating, based upon the plurality of barometric pressure signals, a barometric pressure profile associated with a region, wherein the barometric pressure profile is indicative of one or more barometric pressure measures at one or more locations within the region.

According to some embodiments, the first vehicle device is an ECU of the first vehicle.

According to some embodiments, the first vehicle device is connected to an OBD port of the first vehicle.

According to some embodiments, the method includes receiving, from a second device, information indicative of a second barometric pressure measure determined using a second barometric sensor of the second device and a second location of the second device; and determining, based upon the second barometric pressure measure, the second location and the barometric pressure profile, an altitude of the second device and/or or a barometric offset associated with barometric measurement using the second barometric sensor.

According to some embodiments, the method includes grouping barometric pressure measures, indicated by barometric pressure signals of the plurality of barometric pressure signals, into groups of barometric pressure measures based upon locations associated with the barometric pressure measures, wherein: barometric pressure measures, of a first group of barometric pressure measures of the groups, are associated with second locations within a first area within the region; barometric pressure measures, of a second group of barometric pressure measures of the groups, are associated with third locations within a second area within the region; and generating the barometric pressure profile includes: determining, based upon the first group of barometric pressure measures and the second locations, a first barometric pressure measure, of the one or more barometric pressure measures, at a fourth location of the one or more locations; and determining, based upon the second group of barometric pressure measures and the third locations, a second barometric pressure measure, of the one or more barometric pressure measures, at a fifth location of the one or more locations.

According to some embodiments, each barometric pressure measure of the first group of barometric pressure measures is determined via a barometric measurement performed via a barometric sensor within a first time period.

According to some embodiments, the method includes identifying a third barometric pressure measure, of the first group of barometric pressure measures, associated with a sixth location of the second locations, wherein the third barometric pressure measure is determined via a barometric measurement performed at a first time; converting the third barometric pressure measure associated with the first time to a fourth barometric pressure measure associated with a second time after the first time based upon a fifth barometric pressure measure, associated with the sixth location and the first time, and a sixth barometric pressure measure associated with the sixth location and the second time, wherein: the fourth barometric pressure measure is representative of a barometric pressure measure at the sixth location and at the second time; and the first barometric pressure measure of the one or more barometric pressure measures of the barometric pressure profile is determined based upon the fourth barometric pressure measure.

According to some embodiments, the method includes determining barometric pressure error levels associated with barometric sensors used to determine the barometric pressure measures of the first group of barometric pressure measures, wherein the first barometric pressure measure is determined based upon the barometric pressure error levels.

According to some embodiments, one or more barometric pressure signals of the plurality of barometric pressure signals are indicative of one or more second barometric pressure measures and one or more second locations; and generating the barometric pressure profile includes determining, based upon the one or more second barometric pressure measures and the one or more second locations, a first barometric pressure measure, of the one or more barometric pressure measures, at a second location of the one or more locations.

According to some embodiments, a non-transitory computer-readable medium, storing instructions that when executed perform operations, is provided. The operations include receiving, from a plurality of vehicle devices, a plurality of weather property signals, wherein a first weather property signal of the plurality of weather property signals is received from a first vehicle device, of the plurality of vehicle devices, connected to a first vehicle, and wherein the first weather property signal is indicative of a first location of the first vehicle and one or more first weather property measures determined using one or more first sensors of the first vehicle; and generating, based upon the plurality of weather property signals, a weather profile associated with a region, wherein the weather profile is indicative of one or more second weather property measures at one or more locations within the region.

According to some embodiments, the first vehicle device is an ECU of the first vehicle.

According to some embodiments, the first vehicle device is connected to an OBD port of the first vehicle.

According to some embodiments, the one or more first weather property measures include a first barometric pressure measure determined using a first barometric sensor of the one or more first sensors; and the one or more second weather property measures are one or more barometric pressure measures.

According to some embodiments, the operations include receiving, from a second device, information indicative of a second barometric pressure measure determined using a second barometric sensor of the second device and a second location of the second device; and determining, based upon the second barometric pressure measure, the second location and the weather profile, an altitude of the second device and/or a barometric offset associated with barometric measurement using the second barometric sensor.

According to some embodiments, the operations include grouping weather property measures, indicated by weather property signals of the plurality of weather property signals, into groups of weather property measures based upon locations associated with the weather property measures, wherein: weather property measures, of a first group of weather property measures of the groups, are associated with second locations within a first area within the region; weather property measures, of a second group of weather property measures of the groups, are associated with third locations within a second area within the region; and generating the weather profile includes: determining, based upon the first group of weather property measures and the second locations, a first weather property measure, of the one or more second weather property measures, at a fourth location of the one or more locations; and determining, based upon the second group of weather property measures and the third locations, a second weather property measure, of the one or more second weather property measures, at a fifth location of the one or more locations.

According to some embodiments, each weather property measure of the first group of weather property measures is determined via a measurement performed within a first time period.

According to some embodiments, the operations include determining error levels associated with sensors used to determine the weather property measures of the first group of weather property measures, wherein the first weather property measure is determined based upon the error levels.

According to some embodiments, the one or more first weather property measures include a first temperature measure determined using a first temperature sensor of the one or more first sensors; and the one or more second weather property measures are one or more temperature measures.

According to some embodiments, a device is provided. The device includes a processor coupled to memory, the processor configured to execute instructions to perform operations. The operations include receiving, from a plurality of vehicle devices, a plurality of vehicle measure signals, wherein a first vehicle measure signal of the plurality of vehicle measure signals is received from a first vehicle device, of the plurality of vehicle devices, connected to a first vehicle, and wherein the first vehicle measure signal is indicative of a first location of the first vehicle and one or more first vehicle measures determined using one or more first sensors of the first vehicle; and generating, based upon the plurality of vehicle measure signals, a vehicle measure profile associated with a region, wherein the vehicle measure profile is indicative of one or more second vehicle measures at one or more locations within the region.

According to some embodiments, the first vehicle device is an ECU of the first vehicle and/or the first vehicle device is connected to an OBD port of the first vehicle.

According to some embodiments, the one or more first vehicle measures include a first barometric pressure measure determined using a first barometric sensor of the one or more first sensors; and the one or more second vehicle measures are one or more barometric pressure measures.

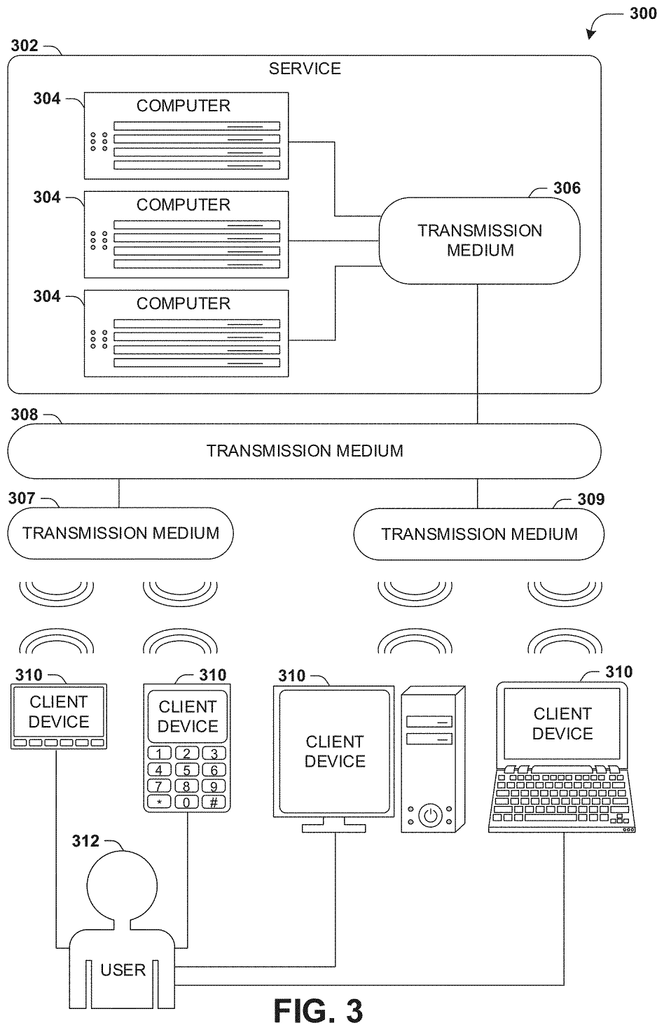

FIG. 3 is an interaction diagram of a scenario 300 illustrating a service 302 provided by a set of computers 304 to a set of client devices 310 via various types of transmission mediums. The computers 304 and/or client devices 310 may be capable of transmitting, receiving, processing, and/or storing many types of signals, such as in memory as physical memory states.

The computers 304 of the service 302 may be communicatively coupled together, such as for exchange of communications using a transmission medium 306. The transmission medium 306 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 302.

Likewise, the transmission medium 306 may comprise one or more sub-networks, such as may employ different architectures, may be compliant or compatible with differing protocols and/or may interoperate within the transmission medium 306. Additionally, various types of transmission medium 306 may be interconnected (e.g., a router may provide a link between otherwise separate and independent transmission medium 306).

In scenario 300 of FIG. 3, the transmission medium 306 of the service 302 is connected to a transmission medium 308 that allows the service 302 to exchange data with other services 302 and/or client devices 310. The transmission medium 308 may encompass various combinations of devices with varying levels of distribution and exposure, such as a public wide-area network and/or a private network (e.g., a virtual private network (VPN) of a distributed enterprise).

In the scenario 300 of FIG. 3, the service 302 may be accessed via the transmission medium 308 by a user 312 of one or more client devices 310, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 310 may communicate with the service 302 via various communicative couplings to the transmission medium 308. As a first such example, one or more client devices 310 may comprise a cellular communicator and may communicate with the service 302 by connecting to the transmission medium 308 via a transmission medium 307 provided by a cellular provider. As a second such example, one or more client devices 310 may communicate with the service 302 by connecting to the transmission medium 308 via a transmission medium 309 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the computers 304 and the client devices 310 may communicate over various types of transmission mediums.

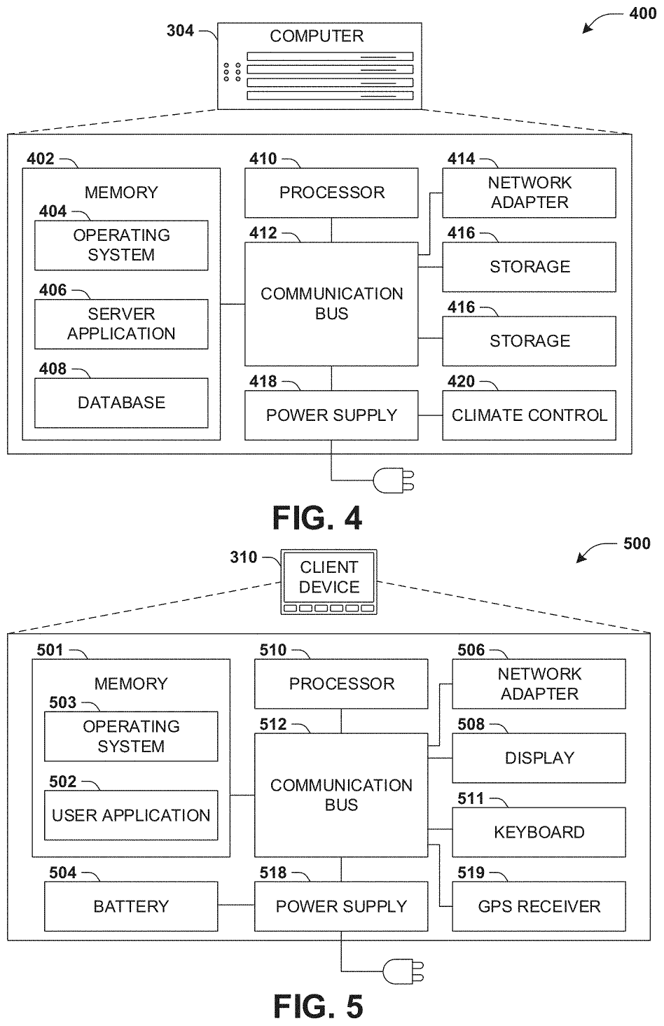

FIG. 4 presents a schematic architecture diagram 400 of a computer 304 that may utilize at least a portion of the techniques provided herein. Such a computer 304 may vary widely in configuration or capabilities, alone or in conjunction with other computers, in order to provide a service such as the service 302.

The computer 304 may comprise one or more processors 410 that process instructions. The one or more processors 410 may optionally include a plurality of cores; one or more coprocessors, such as a mathematics coprocessor or an integrated graphical processing unit (GPU); and/or one or more layers of local cache memory. The computer 304 may comprise memory 402 storing various forms of applications, such as an operating system 404; one or more computer applications 406; and/or various forms of data, such as a database 408 or a file system. The computer 304 may comprise a variety of peripheral components, such as a wired and/or wireless network adapter 414 connectible to a local area network and/or wide area network; one or more storage components 416, such as a hard disk drive, a solid-state storage device (SSD), a flash memory device, and/or a magnetic and/or optical disk reader.

The computer 304 may comprise a mainboard featuring one or more communication buses 412 that interconnect the processor 410, the memory 402, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 412 may interconnect the computer 304 with at least one other computer. Other components that may optionally be included with the computer 304 (though not shown in the schematic architecture diagram 400 of FIG. 4) include a display; a display adapter, such as a graphical processing unit (GPU); input peripherals, such as a keyboard and/or mouse; and a flash memory device that may store a basic input/output system (BIOS) routine that facilitates booting the computer 304 to a state of readiness.

The computer 304 may operate in various physical enclosures, such as a desktop or tower, and/or may be integrated with a display as an “all-in-one” device. The computer 304 may be mounted horizontally and/or in a cabinet or rack, and/or may simply comprise an interconnected set of components. The computer 304 may comprise a dedicated and/or shared power supply 418 that supplies and/or regulates power for the other components. The computer 304 may provide power to and/or receive power from another computer and/or other devices. The computer 304 may comprise a shared and/or dedicated climate control unit 420 that regulates climate properties, such as temperature, humidity, and/or airflow. Many such computers 304 may be configured and/or adapted to utilize at least a portion of the techniques presented herein.

FIG. 5 presents a schematic architecture diagram 500 of a client device 310 whereupon at least a portion of the techniques presented herein may be implemented. Such a client device 310 may vary widely in configuration or capabilities, in order to provide a variety of functionality to a user such as the user 312. The client device 310 may be provided in a variety of form factors, such as a desktop or tower workstation; an “all-in-one” device integrated with a display 508; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 310 may serve the user in a variety of roles, such as a workstation, kiosk, media player, gaming device, and/or appliance.

The client device 310 may comprise one or more processors 510 that process instructions. The one or more processors 510 may optionally include a plurality of cores; one or more coprocessors, such as a mathematics coprocessor or an integrated graphical processing unit (GPU); and/or one or more layers of local cache memory. The client device 310 may comprise memory 501 storing various forms of applications, such as an operating system 503; one or more user applications 502, such as document applications, media applications, file and/or data access applications, communication applications such as web browsers and/or email clients, utilities, and/or games; and/or drivers for various peripherals. The client device 310 may comprise a variety of peripheral components, such as a wired and/or wireless network adapter 506 connectible to a local area network and/or wide area network; one or more output components, such as a display 508 coupled with a display adapter (optionally including a graphical processing unit (GPU)), a sound adapter coupled with a speaker, and/or a printer; input devices for receiving input from the user, such as a keyboard 511, a mouse, a microphone, a camera, and/or a touch-sensitive component of the display 508; and/or environmental sensors, such as a global positioning system (GPS) receiver 519 that detects the location, velocity, and/or acceleration of the client device 310, a compass, accelerometer, and/or gyroscope that detects a physical orientation of the client device 310. Other components that may optionally be included with the client device 310 (though not shown in the schematic architecture diagram 500 of FIG. 5) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 310 to a state of readiness; and a climate control unit that regulates climate properties, such as temperature, humidity, and airflow.

The client device 310 may comprise a mainboard featuring one or more communication buses 512 that interconnect the processor 510, the memory 501, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 310 may comprise a dedicated and/or shared power supply 518 that supplies and/or regulates power for other components, and/or a battery 504 that stores power for use while the client device 310 is not connected to a power source via the power supply 518. The client device 310 may provide power to and/or receive power from other client devices.

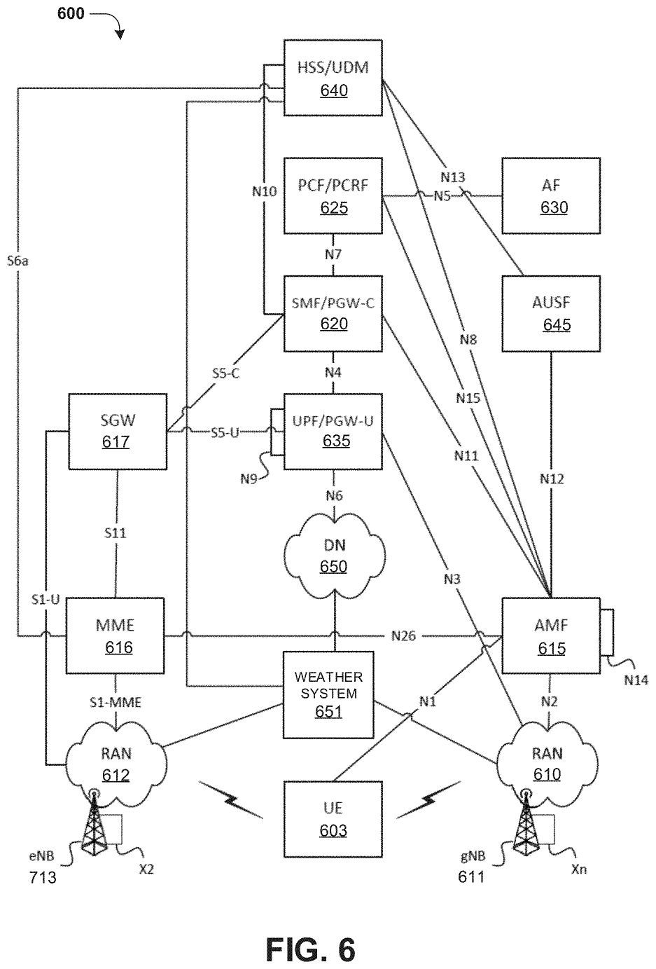

FIG. 6 illustrates an example environment 600, in which one or more embodiments may be implemented. In some embodiments, environment 600 may correspond to a Fifth Generation (“5G”) network, and/or may include elements of a 5G network. In some embodiments, environment 600 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). As shown, environment 600 may include UE 603, RAN 610 (which may include one or more Next Generation Node Bs (“gNBs”) 611), RAN 612 (which may include one or more one or more evolved Node Bs (“eNBs”) 613), and various network functions such as Access and Mobility Management Function (“AMF”) 615, Mobility Management Entity (“MME”) 616, Serving Gateway (“SGW”) 617, Session Management Function (“SMF”)/Packet Data Network (“PDN”) Gateway (“PGW”)-Control plane function (“PGW-C”) 620, Policy Control Function (“PCF”)/Policy Charging and Rules Function (“PCRF”) 625, Application Function (“AF”) 630, User Plane Function (“UPF”)/PGW-User plane function (“PGW-U”) 635, Home Subscriber Server (“HSS”)/Unified Data Management (“UDM”) 640, and Authentication Server Function (“AUSF”) 645. Environment 600 may also include one or more networks, such as Data Network (“DN”) 650. Environment 600 may include one or more additional devices or systems communicatively coupled to one or more networks (e.g., DN 650), such as weather system 651.

The example shown in FIG. 6 illustrates one instance of each network component or function (e.g., one instance of SMF/PGW-C 620, PCF/PCRF 625, UPF/PGW-U 635, HSS/UDM 640, and/or 645). In practice, environment 600 may include multiple instances of such components or functions. For example, in some embodiments, environment 600 may include multiple “slices” of a core network, where each slice includes a discrete set of network functions (e.g., one slice may include a first instance of SMF/PGW-C 620, PCF/PCRF 625, UPF/PGW-U 635, HSS/UDM 640, and/or 645, while another slice may include a second instance of SMF/PGW-C 620, PCF/PCRF 625, UPF/PGW-U 635, HSS/UDM 640, and/or 645). The different slices may provide differentiated levels of service, such as service in accordance with different Quality of Service (“QoS”) parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. Alternatively and/or additionally, one or more of the devices of environment 600 may perform one or more network functions described as being performed by another one or more of the devices of environment 600. Devices of environment 600 may interconnect with each other and/or other devices via wired connections, wireless connections, or a combination of wired and wireless connections. In some implementations, one or more devices of environment 600 may be physically integrated in, and/or may be physically attached to, one or more other devices of environment 600.

UE 603 may include a computation and communication device, such as a wireless mobile communication device that is capable of communicating with RAN 610, RAN 612, and/or DN 650. UE 603 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, or the like), a wearable device, an Internet of Things (“IoT”) device, a Mobile-to-Mobile (“M2M”) device, or another type of mobile computation and communication device. UE 603 may send traffic to and/or receive traffic (e.g., user plane traffic) from DN 650 via RAN 610, RAN 612, and/or UPF/PGW-U 635.

RAN 610 may be, or may include, a 5G RAN that includes one or more base stations (e.g., one or more gNBs 611), via which UE 603 may communicate with one or more other elements of environment 600. UE 603 may communicate with RAN 610 via an air interface (e.g., as provided by gNB 611). For instance, RAN 610 may receive traffic (e.g., voice call traffic, data traffic, messaging traffic, signaling traffic, etc.) from UE 603 via the air interface, and may communicate the traffic to UPF/PGW-U 635, and/or one or more other devices or networks. Similarly, RAN 610 may receive traffic intended for UE 603 (e.g., from UPF/PGW-U 635, AMF 615, and/or one or more other devices or networks) and may communicate the traffic to UE 603 via the air interface.

RAN 612 may be, or may include, a LTE RAN that includes one or more base stations (e.g., one or more eNBs 613), via which UE 603 may communicate with one or more other elements of environment 600. UE 603 may communicate with RAN 612 via an air interface (e.g., as provided by eNB 613). For instance, RAN 610 may receive traffic (e.g., voice call traffic, data traffic, messaging traffic, signaling traffic, etc.) from UE 603 via the air interface, and may communicate the traffic to UPF/PGW-U 635, and/or one or more other devices or networks. Similarly, RAN 610 may receive traffic intended for UE 603 (e.g., from UPF/PGW-U 635, SGW 617, and/or one or more other devices or networks) and may communicate the traffic to UE 603 via the air interface.

AMF 615 may include one or more devices, systems, Virtualized Network Functions (“VNFs”), etc., that perform operations to register UE 603 with the 5G network, to establish bearer channels associated with a session with UE 603, to hand off UE 603 from the 5G network to another network, to hand off UE 603 from the other network to the 5G network, manage mobility of UE 603 between RANs 610 and/or gNBs 611, and/or to perform other operations. In some embodiments, the 5G network may include multiple AMFs 615, which communicate with each other via the N14 interface (denoted in FIG. 6 by the line marked “N14” originating and terminating at AMF 615).

MME 616 may include one or more devices, systems, VNFs, etc., that perform operations to register UE 603 with the EPC, to establish bearer channels associated with a session with UE 603, to hand off UE 603 from the EPC to another network, to hand off UE 603 from another network to the EPC, manage mobility of UE 603 between RANs 612 and/or eNBs 613, and/or to perform other operations.

SGW 617 may include one or more devices, systems, VNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, etc., that gather, process, store, and/or provide information in a manner described herein. SMF/PGW-C 620 may, for example, facilitate in the establishment of communication sessions on behalf of UE 603. In some embodiments, the establishment of communications sessions may be performed in accordance with one or more policies provided by PCF/PCRF 625.

PCF/PCRF 625 may include one or more devices, systems, VNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, etc., that receive, store, and/or provide information that may be used in determining parameters (e.g., quality of service parameters, charging parameters, or the like) for certain applications.

UPF/PGW-U 635 may include one or more devices, systems, VNFs, etc., that receive, store, and/or provide data (e.g., user plane data). For example, UPF/PGW-U 635 may receive user plane data (e.g., voice call traffic, data traffic, etc.), destined for UE 603, from DN 650, and may forward the user plane data toward UE 603 (e.g., via RAN 610, SMF/PGW-C 620, and/or one or more other devices). In some embodiments, multiple UPFs 635 may be deployed (e.g., in different geographical locations), and the delivery of content to UE 603 may be coordinated via the N9 interface (e.g., as denoted in FIG. 6 by the line marked “N9” originating and terminating at UPF/PGW-U 635). Similarly, UPF/PGW-U 635 may receive traffic from UE 603 (e.g., via RAN 610, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

HSS/UDM 640 and AUSF 645 may include one or more devices, systems, VNFs, etc., that manage, update, and/or store, in one or more memory devices associated with AUSF 645 and/or HSS/UDM 640, profile information associated with a subscriber. AUSF 645 and/or HSS/UDM 640 may perform authentication, authorization, and/or accounting operations associated with the subscriber and/or a communication session with UE 603.

DN 650 may include one or more wired and/or wireless networks. For example, DN 650 may include an Internet Protocol (“IP”)-based PDN, a wide area network (“WAN”) such as the Internet, a private enterprise network, and/or one or more other networks. UE 603 may communicate, through DN 650, with data servers, other UEs UE 603, and/or to other servers or applications that are coupled to DN 650. DN 650 may be connected to one or more other networks, such as a public switched telephone network (“PSTN”), a public land mobile network (“PLMN”), and/or another network. DN 650 may be connected to one or more devices, such as content providers, applications, web servers, and/or other devices, with which UE 603 may communicate.

The weather system 651 may include one or more devices, systems, VNFs, etc., that perform one or more operations described herein. For example, the weather system 651 may at least one of receive vehicle measure signals from vehicle devices, generate a vehicle measure profile (e.g., a weather profile) based upon the vehicle measure signals, determine a weather property measure associated with a location using the vehicle measure profile, determine an offset associated with a sensor using the vehicle measure profile, determine a device altitude and/or locating information associated with a device (e.g., the UE 603), etc. Alternatively and/or additionally, the weather system 651 may present the locating information via an interface and/or transmit the locating information to one or more devices, such as at least one of the UE 703, a first responder management device, etc.

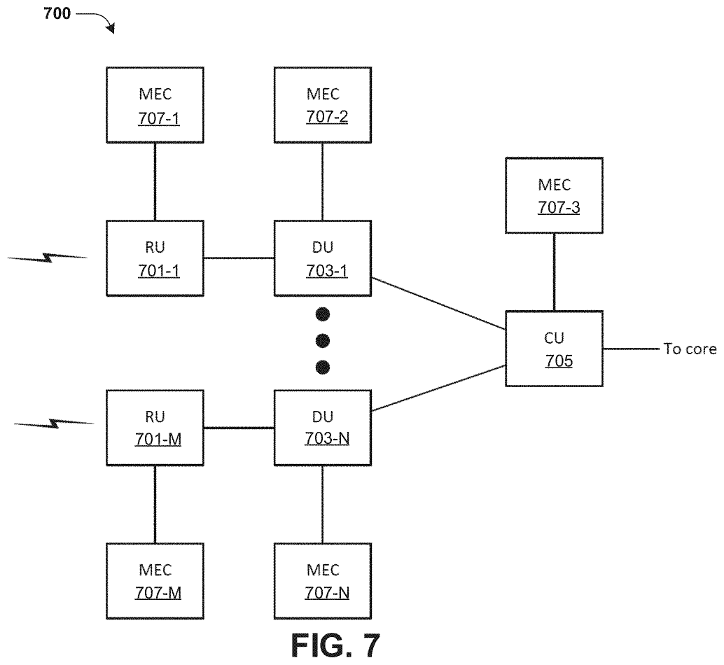

FIG. 7 illustrates an example Distributed Unit (“DU”) network 700, which may be included in and/or implemented by one or more RANs (e.g., RAN 610, RAN 612, or some other RAN). In some embodiments, a particular RAN may include one DU network 700. In some embodiments, a particular RAN may include multiple DU networks 700. In some embodiments, DU network 700 may correspond to a particular gNB 611 of a 5G RAN (e.g., RAN 610). In some embodiments, DU network 700 may correspond to multiple gNBs 611. In some embodiments, DU network 700 may correspond to one or more other types of base stations of one or more other types of RANs. As shown, DU network 700 may include Central Unit (“CU”) 705, one or more Distributed Units (“DUs”) 703-1 through 703-N (referred to individually as “DU 703,” or collectively as “DUs 703”), and one or more Radio Units (“RUs”) 701-1 through 701-M (referred to individually as “RU 701,” or collectively as “RUs 701”).

CU 705 may communicate with a core of a wireless network (e.g., may communicate with one or more of the devices or systems described above with respect to FIG. 6, such as AMF 615 and/or UPF/PGW-U 635). In the uplink direction (e.g., for traffic from UEs UE 603 to a core network), CU 705 may aggregate traffic from DUs 703, and forward the aggregated traffic to the core network. In some embodiments, CU 705 may receive traffic according to a given protocol (e.g., Radio Link Control (“RLC”)) from DUs 703, and may perform higher-layer processing (e.g., may aggregate/process RLC packets and generate Packet Data Convergence Protocol (“PDCP”) packets based upon the RLC packets) on the traffic received from DUs 703.

In accordance with some embodiments, CU 705 may receive downlink traffic (e.g., traffic from the core network) for a particular UE 603, and may determine which DU(s) 703 should receive the downlink traffic. DU 703 may include one or more devices that transmit traffic between a core network (e.g., via CU 705) and UE 603 (e.g., via a respective RU 701). DU 703 may, for example, receive traffic from RU 701 at a first layer (e.g., physical (“PHY”) layer traffic, or lower PHY layer traffic), and may process/aggregate the traffic to a second layer (e.g., upper PHY and/or RLC). DU 703 may receive traffic from CU 705 at the second layer, may process the traffic to the first layer, and provide the processed traffic to a respective RU 701 for transmission to UE 603.

RU 701 may include hardware circuitry (e.g., one or more RF transceivers, antennas, radios, and/or other suitable hardware) to communicate wirelessly (e.g., via an RF interface) with one or more UEs UE 603, one or more other DUs 703 (e.g., via RUs 701 associated with DUs 703), and/or any other suitable type of device. In the uplink direction, RU 701 may receive traffic from UE 603 and/or another DU 703 via the RF interface and may provide the traffic to DU 703. In the downlink direction, RU 701 may receive traffic from DU 703, and may provide the traffic to UE 603 and/or another DU 703.

RUs 701 may, in some embodiments, be communicatively coupled to one or more Multi-Access/Mobile Edge Computing (“MEC”) devices, referred to sometimes herein simply as (“MECs”) 707. For example, RU 701-1 may be communicatively coupled to MEC 707-1, RU 701-M may be communicatively coupled to MEC 707-M, DU 703-1 may be communicatively coupled to MEC 707-2, DU 703-N may be communicatively coupled to MEC 707-N, CU 705 may be communicatively coupled to MEC 707-3, and so on. MECs 707 may include hardware resources (e.g., configurable or provisionable hardware resources) that may be configured to provide services and/or otherwise process traffic to and/or from UE 603, via a respective RU 701.

For example, RU 701-1 may route some traffic, from UE 603, to MEC 707-1 instead of to a core network (e.g., via DU 703 and CU 705). MEC 707-1 may process the traffic, perform one or more computations based upon the received traffic, and may provide traffic to UE 603 via RU 701-1. In this manner, ultra-low latency services may be provided to UE 603, as traffic does not need to traverse DU 703, CU 705, and an intervening backhaul network between DU network 700 and the core network. In some embodiments, MEC 707 may include, and/or may implement some or all of the functionality described above with respect to at least one of the weather system 651, the weather system 102, the device 160, etc.

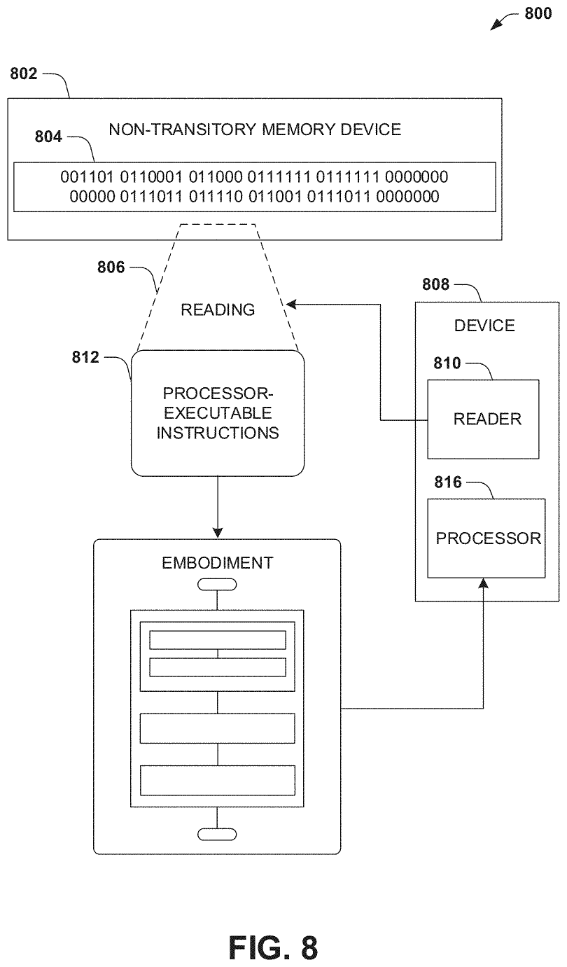

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein. The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 200 of FIG. 2, for example. In some embodiments, the processor-executable instructions 812 are configured to cause implementation of a system, such as at least some of the example system 101 of FIGS. 1A-1F, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method comprising:
receiving, from a plurality of vehicle devices, a plurality of barometric pressure signals, wherein:
a first barometric pressure signal of the plurality of barometric pressure signals is received from a first vehicle device, of the plurality of vehicle devices, connected to a first vehicle; and
the first barometric pressure signal is indicative of a first location of the first vehicle and one or more first barometric pressure measures determined using a first barometric sensor of the first vehicle; and
generating, based upon the plurality of barometric pressure signals, a barometric pressure profile associated with a region, wherein the barometric pressure profile is indicative of one or more barometric pressure measures at one or more locations within the region.

2. The method of claim 1, wherein:
the first vehicle device is an electronic control unit (ECU) of the first vehicle.

3. The method of claim 1, wherein:
the first vehicle device is connected to an on-board diagnostics (OBD) port of the first vehicle.

4. The method of claim 1, comprising:
receiving, from a second device, information indicative of:
a second barometric pressure measure determined using a second barometric sensor of the second device; and
a second location of the second device; and
determining, based upon the second barometric pressure measure, the second location and the barometric pressure profile, at least one of an altitude of the second device or a barometric offset associated with barometric measurement using the second barometric sensor.

5. The method of claim 1, comprising:
grouping barometric pressure measures, indicated by barometric pressure signals of the plurality of barometric pressure signals, into groups of barometric pressure measures based upon locations associated with the barometric pressure measures, wherein:
barometric pressure measures, of a first group of barometric pressure measures of the groups, are associated with second locations within a first area within the region;
barometric pressure measures, of a second group of barometric pressure measures of the groups, are associated with third locations within a second area within the region; and
generating the barometric pressure profile comprises:
determining, based upon the first group of barometric pressure measures and the second locations, a first barometric pressure measure, of the one or more barometric pressure measures, at a fourth location of the one or more locations; and
determining, based upon the second group of barometric pressure measures and the third locations, a second barometric pressure measure, of the one or more barometric pressure measures, at a fifth location of the one or more locations.

6. The method of claim 5, wherein:
each barometric pressure measure of the first group of barometric pressure measures is determined via a barometric measurement performed via a barometric sensor within a first time period.

7. The method of claim 5, comprising:
identifying a third barometric pressure measure, of the first group of barometric pressure measures, associated with a sixth location of the second locations, wherein the third barometric pressure measure is determined via a barometric measurement performed at a first time;
converting the third barometric pressure measure associated with the first time to a fourth barometric pressure measure associated with a second time after the first time based upon:
a fifth barometric pressure measure, associated with the sixth location and the first time; and
a sixth barometric pressure measure associated with the sixth location and the second time, wherein:
the fourth barometric pressure measure is representative of a barometric pressure measure at the sixth location and at the second time; and
the first barometric pressure measure of the one or more barometric pressure measures of the barometric pressure profile is determined based upon the fourth barometric pressure measure.

8. The method of claim 5, comprising:
determining barometric pressure error levels associated with barometric sensors used to determine the barometric pressure measures of the first group of barometric pressure measures, wherein the first barometric pressure measure is determined based upon the barometric pressure error levels.

9. The method of claim 1, wherein:
one or more barometric pressure signals of the plurality of barometric pressure signals are indicative of one or more second barometric pressure measures and one or more second locations; and
generating the barometric pressure profile comprises determining, based upon the one or more second barometric pressure measures and the one or more second locations, a first barometric pressure measure, of the one or more barometric pressure measures, at a second location of the one or more locations.

10. A non-transitory computer-readable medium storing instructions that when executed perform operations comprising:
receiving, from a plurality of vehicle devices, a plurality of weather property signals, wherein:
a first weather property signal of the plurality of weather property signals is received from a first vehicle device, of the plurality of vehicle devices, connected to a first vehicle; and
the first weather property signal is indicative of a first location of the first vehicle and one or more first weather property measures determined using one or more first sensors of the first vehicle; and
generating, based upon the plurality of weather property signals, a weather profile associated with a region, wherein the weather profile is indicative of one or more second weather property measures at one or more locations within the region.

11. The non-transitory computer-readable medium of claim 10, wherein:
the first vehicle device is an electronic control unit (ECU) of the first vehicle.

12. The non-transitory computer-readable medium of claim 10, wherein:
the first vehicle device is connected to an on-board diagnostics (OBD) port of the first vehicle.

13. The non-transitory computer-readable medium of claim 10, wherein:
the one or more first weather property measures comprise a first barometric pressure measure determined using a first barometric sensor of the one or more first sensors; and
the one or more second weather property measures are one or more barometric pressure measures.

14. The non-transitory computer-readable medium of claim 13, the operations comprising:
receiving, from a second device, information indicative of:
a second barometric pressure measure determined using a second barometric sensor of the second device; and
a second location of the second device; and
determining, based upon the second barometric pressure measure, the second location and the weather profile, at least one of an altitude of the second device or a barometric offset associated with barometric measurement using the second barometric sensor.

15. The non-transitory computer-readable medium of claim 10, the operations comprising:
grouping weather property measures, indicated by weather property signals of the plurality of weather property signals, into groups of weather property measures based upon locations associated with the weather property measures, wherein:
weather property measures, of a first group of weather property measures of the groups, are associated with second locations within a first area within the region;
weather property measures, of a second group of weather property measures of the groups, are associated with third locations within a second area within the region; and
generating the weather profile comprises:
determining, based upon the first group of weather property measures and the second locations, a first weather property measure, of the one or more second weather property measures, at a fourth location of the one or more locations; and
determining, based upon the second group of weather property measures and the third locations, a second weather property measure, of the one or more second weather property measures, at a fifth location of the one or more locations.

16. The non-transitory computer-readable medium of claim 15, wherein:
each weather property measure of the first group of weather property measures is determined via a measurement performed within a first time period.

17. The non-transitory computer-readable medium of claim 15, the operations comprising:
determining error levels associated with sensors used to determine the weather property measures of the first group of weather property measures, wherein the first weather property measure is determined based upon the error levels.

18. The non-transitory computer-readable medium of claim 10, wherein:
the one or more first weather property measures comprise a first temperature measure determined using a first temperature sensor of the one or more first sensors; and
the one or more second weather property measures are one or more temperature measures.

19. A device comprising:
a processor coupled to memory, the processor configured to execute instructions to perform operations comprising:
receiving, from a plurality of vehicle devices, a plurality of vehicle measure signals, wherein:
a first vehicle measure signal of the plurality of vehicle measure signals is received from a first vehicle device, of the plurality of vehicle devices, connected to a first vehicle; and
the first vehicle measure signal is indicative of a first location of the first vehicle and one or more first vehicle measures determined using one or more first sensors of the first vehicle; and
generating, based upon the plurality of vehicle measure signals, a vehicle measure profile associated with a region, wherein the vehicle measure profile is indicative of one or more second vehicle measures at one or more locations within the region.

20. The device of claim 19, wherein at least one of:
the first vehicle device is an electronic control unit (ECU) of the first vehicle; or
the first vehicle device is connected to an on-board diagnostics (OBD) port of the first vehicle.
